(19) United States
(12) Patent Application Publication
(10) Pub. No.: US 2022/0227360 A1
(43) Pub. Date: Jul. 21, 2022

(54) DISTRIBUTED METHOD AND SYSTEM FOR COLLISION AVOIDANCE BETWEEN VULNERABLE ROAD USERS AND VEHICLES

(71) Applicant: B&H Licensing Inc., Berkeley, CA (US)

(72) Inventors: Romain Delhaye, Montreal (CA); Bastien Beauchamp, Montreal (CA); Jean Francois Viens, Quebec (CA)

(21) Appl. No.: 17/574,987

(22) Filed: Jan. 13, 2022

Related U.S. Application Data
(60) Provisional application No. 63/138,268, filed on Jan. 15, 2021.

(51) Int. Cl. B60W 30/09; B60W 60/00; H04W 64/00; G06N 20/00

(52) U.S. Cl. CPC B60W 30/09; B60W 60/0017; B60W 2554/4029; G06N 20/00; H04W 64/003

(57) ABSTRACT

A distributed method and system for collision avoidance between vulnerable road users (VRUs) and vehicles is provided. The method and system provide for pedestrian-to-vehicle (P2V) collision avoidance, in the field of intelligent transportation technology and data analytics with an artificial intelligence (AI) algorithm distributed among edge and cloud systems. The distribution of data analytics is weighted between edge and cloud systems: the cloud system referring to a Neural Network computational algorithm embedded in a distant server, and the edge system referring to a user equipment (UE) mobile terminal having a P2V collision avoidance applicative algorithm. The described technology can provide P2V danger notifications relating to the field of road safety, and pertaining to collision avoidance, before accidents happen. The described technology relates to precautions collision avoidance notifications using past, current, and predicted trajectories of VRUs and vehicles, based on an AI algorithm distributed among edge and cloud systems.

### RELATED APPLICATIONS

This application claims priority to and the benefit of Provisional Application No. 63/138,268 filed on Jan. 15, 2021, in the U.S. Patent and Trademark Office, the entire contents of which are incorporated herein by reference.

### BACKGROUND

### Technological Field

The described technology generally relates to the field of road safety. More specifically, the described technology relates to a method and a system for collision avoidance between vulnerable road users (VRUs) and vehicles as a distributed artificial intelligence (AI) among edge and cloud systems. More specifically, the described technology relates to a method and a system for pedestrian-to-vehicle (P2V) collision avoidance.

### Description of the Related Technology

Mobile terminals, smartphones, and tablets are now the primary computing devices for many people. In many cases, these devices are rarely separated from their owners, and the combination of rich user interactions and powerful sensors means they have access to an unprecedented amount of data, much of it private in nature. Models learned on such data hold the promise of greatly improving usability by powering more intelligent applications, but the sensitive nature of the data means there are risks and responsibilities to storing the data in a centralized location.

### SUMMARY OF CERTAIN INVENTIVE ASPECTS

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing systems, devices, and methods for jaywalking detection.

One inventive aspect of the present disclosure is a method for collision avoidance between vulnerable road users (VRUs) and vehicles, the method comprising: linking, to a plurality of vehicles, long-term evolution (LTE)-capable user equipment (UE) terminals; and linking, to a plurality of VRU, LTE-capable UE terminals; and first selecting, at a communications server, a first number of the UE terminals, wherein the first selection comprises receiving past spatiotemporal trajectory data from one or more sensors associated with each of the selected UE terminals; and storing the past spatiotemporal trajectory of each of the selected UE terminals; and first determining a machine learning model for predicting the future spatiotemporal trajectory of any one of the selected UE terminals, wherein the communications server comprises computer-executable instructions configured to perform spatiotemporal trajectory prediction and spatiotemporal crowd behavior prediction based on machine learning training; and sending, to each of the selected UE terminals, the machine learning model configuration and machine learning model parameters; and executing, at each of the selected UE terminals, the machine learning model, wherein the executing comprises receiving the machine learning model configuration and machine learning model parameters; and inputting, into the machine learning model, present spatiotemporal trajectory data from one or more sensors associated with each of the selected UE terminals; and obtaining, at the processor of each of the selected UE terminals, the predicted spatiotemporal trajectory of the selected UE terminal, wherein each of the selected UE terminals comprises computer-executable instructions configured to perform spatiotemporal trajectory prediction based on the received machine learning model configuration and parameters; and sending, to the communications server, the spatiotemporal trajectory prediction results; and second selecting, at a communications server, a second number of the UE terminals, wherein the second selection comprises aggregating the spatiotemporal trajectory prediction results of the first number of the UE terminals; and second determining whether the predicted spatiotemporal distance between any one of the first number of the UE terminals is within a proximity range; and obtaining a communications server notification if the second determining relates to a UE terminal belonging to a vehicle and a UE terminal belonging to a VRU; and tagging these two UE terminals as notified UE terminals; and providing, for each of the notified UE terminals, a danger notification pertaining to road usage safety.

Another inventive aspect of the present disclosure is a system for collision avoidance between vulnerable road users (VRUs) and vehicles, the system comprising: a plurality of vehicles linked to LTE-capable UE terminals; and a plurality of VRU linked to LTE-capable UE terminals; and a communications server device configured to select a first number of the UE terminals; and to receive past spatiotemporal trajectory data from one or more sensors associated with each of the selected UE terminals; and to store the past spatiotemporal trajectory of each of the selected UE terminals; and to first determine a machine learning model for predicting the future spatiotemporal trajectory of any one of the selected UE terminals, wherein the communications server comprises computer-executable instructions configured to perform spatiotemporal trajectory prediction and spatiotemporal crowd behavior prediction based on machine learning training; and to send, to each of the selected UE terminals, the machine learning model configuration and machine learning model parameters; and wherein each of the selected UE terminals is configured to execute the machine learning model; and to receive the machine learning model configuration and machine learning model parameters; and to input, into the machine learning model, present spatiotemporal trajectory data from one or more sensors associated with each of the selected UE terminals; and to obtain, at the processor of each of the selected UE terminals, the predicted spatiotemporal trajectory of the selected UE terminal, wherein each of the selected UE terminals comprises computer-executable instructions configured to perform spatiotemporal trajectory prediction based on the received machine learning model configuration and parameters; and to send, to the communications server device, the spatiotemporal trajectory prediction results; and wherein the communications server device is configured to select a second number of the UE terminals; and to aggregate the spatiotemporal trajectory prediction results of the first number of the UE terminals; and to second determine whether the predicted spatiotemporal distance between any one of the first number of the UE terminals is within a proximity range; and to obtain a communications server notification if the second determining relates to a UE terminal belonging to a vehicle and a UE terminal belonging to a VRU; and tagging these two UE terminals as notified UE terminals; and to provide, for each of the notified UE terminals, a danger notification pertaining to road usage safety.

Yet another inventive aspect is a for collision avoidance between vulnerable road users (VRUs) and vehicles, the method comprising: linking, to a plurality of vehicles and to a plurality of VRUs, long-term evolution (LTE)-capable user equipment (UE) terminals having an international mobile subscriber identity (IMSI); first selecting, at a communications server, a first number of the UE terminals, wherein the first selection comprises: receiving past spatiotemporal trajectory data from one or more sensors associated with each of the selected UE terminals; storing the past spatiotemporal trajectory of each of the selected UE terminals; first determining a machine learning model for predicting a future spatiotemporal trajectory of any one of the selected UE terminals, wherein the communications server comprises computer-executable instructions configured to perform spatiotemporal trajectory prediction and spatiotemporal crowd behavior prediction based on machine learning training; sending, to each of the selected UE terminals, a machine learning model configuration and machine learning model parameters; and executing, at each of the selected UE terminals, the machine learning model, wherein the executing comprises: receiving the machine learning model configuration and machine learning model parameters; inputting, into the machine learning model, present spatiotemporal trajectory data from the one or more sensors associated with each of the selected UE terminals; obtaining, at a processor of each of the selected UE terminals, a predicted spatiotemporal trajectory of each selected UE terminal, wherein each of the selected UE terminals comprises computer-executable instructions configured to perform the spatiotemporal trajectory prediction based on the received machine learning model configuration and parameters; and sending, to the communications server, results of the spatiotemporal trajectory prediction; and second selecting, at the communications server, a second number of the UE terminals, wherein the second selecting comprises: aggregating the spatiotemporal trajectory prediction results of the first number of the UE terminals; second determining whether the predicted spatiotemporal distance between any one of the first number of the UE terminals is within a proximity range; obtaining a communications server notification if the second determining relates to a first one of the UE terminals belonging to one of the vehicles and a second one of the UE terminals belonging to one of the VRUs; tagging the first and second UE terminals as notified UE terminals; and providing, to the notified UE terminals, a danger notification pertaining to road usage safety.

In some embodiments, the second selecting further comprises receiving an acknowledgement of the communications server notification from the notified UE terminals.

In some embodiments, the acknowledgement is based on activating a proximity signal between the first and second notified UE terminals.

In some embodiments, the proximity signal includes a radio frequency communications configured to be implemented with any one of IEEE 802, IEEE 802.11, or IEEE 802.15 signal protocols, or a combination thereof.

In some embodiments, the proximity signal is configured to be generated by an interoperable system that communicates with an intelligent transportation systems (ITS)-based standard, including at least one of: dedicated short-range communications (DSRC), LTE, and cellular vehicle-to-everything (C-V2X) communications.

In some embodiments, the communications server notification includes a duet comprising a mobile equipment identifier (MEID) of the first notified UE terminal belonging to the vehicle and the MEID of the second notified UE terminal belonging to the VRU.

In some embodiments, the danger notification includes an information message, a warning message, an alert message, a prescription for danger avoidance, a prescription for collision avoidance, a prescription for moral conflict resolution, a statement of local applicable road regulations, a warning for obeying road regulations, an audible message, a visual message, a haptic message, a cognitive message, any notification pertaining to road safety, or any combination thereof.

In some embodiments, the prescription for collision avoidance includes a prescription for applying brakes to slow down or to stop the vehicle through an advanced driver assistant system (ADAS) or an automated driving system (ADS) of the notified vehicle.

In some embodiments, the proximity signal comprises the communications server notification and the danger notification.

In some embodiments, providing the danger notification further comprises transmitting the danger notification to a communications network infrastructure, a road traffic infrastructure, a pedestrian crosswalk infrastructure, a cloud computing server, an edge computing device, an Internet of things (IoT) device, a fog computing device, any information terminal pertaining to the field of road safety, or a combination thereof.

In some embodiments, the communications server includes any one of a location service client (LCS) server, an LTE base station (BS) server, an LTE wireless network communications server, a gateway server, a cellular service provider server, a cloud server, or a combination thereof.

In some embodiments, the UE terminals further comprise global navigation satellite systems (GNSS)-capable sensors, global positioning system (GPS)-capable sensors, microelectromechanical (MEMS) accelerometer sensors, of MEMS gyroscope sensors, or an interoperable combination thereof.

In some embodiments, the UE terminals include smartphones, Internet of things (IoT) devices, tablets, advanced driver assistant systems (ADAS), automated driving systems (ADS), any other portable information terminals, mobile terminals, or a combination thereof.

In some embodiments, the LTE uses 5G NR new radio access technology (RAT).

In some embodiments, the machine learning model includes a dead reckoning algorithm, an artificial intelligence algorithm, a recurrent neural network (RNN) algorithm, a reinforcement learning (RL) algorithm, a conditional random fields (CRFs) algorithm, or a combination thereof.

In some embodiments, the communications server is configured to train the machine learning model using a set of spatiotemporal trajectory data comprising position, speed, acceleration, and/or direction components, or a combination thereof, of any one of the UE terminals.

In some embodiments, the processor of each of the selected UE terminals is configured to execute the machine learning model using model configuration and model parameters.

In some embodiments, the machine learning model includes a federated learning model.

In some embodiments, the proximity range has the shape of an ellipse, wherein the major axis of the ellipse is coincident with the predicted spatiotemporal trajectory of the notified UE terminal belonging to the vehicle, and wherein the major axis length is about 20 meters or longer.

In some embodiments, the VRUs comprise non-motorized road users including: pedestrians, construction workers, emergency services workers, policemen, firefighters, bicyclists, or wheelchair users; motorized road users including: scooters or motorcyclists; or persons with disabilities, reduced mobility, or orientation.

In some embodiments, the vehicles comprise any motor propelled device that could present a road hazard for VRUs, including: cars, autonomous vehicles, non-autonomous vehicles, self-driving vehicles, off-road vehicles, trucks, manufacturing vehicles, industrial vehicles, safety and security vehicles, electric vehicles, low-altitude airplanes, helicopters, drones, or boats, and wherein the vehicles further comprise any other type of automotive, aerial, or naval vehicles with some proximity to VRUs encountered in urban, industrial, commercial, airport, or naval environments.

Still yet another inventive aspect is a system for collision avoidance between vulnerable road users (VRUs) and vehicles, the system comprising: a communications server comprising computer-executable instructions configured to perform spatiotemporal trajectory prediction and spatiotemporal crowd behavior prediction based on machine learning training, the communications server configured to: select a first number of long-term evolution (LTE)-capable user equipment (UE) terminals having an international mobile subscriber identity (IMSI), wherein each of the UE terminals is linked to a vehicle or a VRU, receive past spatiotemporal trajectory data from one or more sensors associated with each of the selected UE terminals, store the past spatiotemporal trajectory of each of the selected UE terminals, first determine a machine learning model for predicting a future spatiotemporal trajectory of any one the selected UE terminals, send, to each of the selected UE terminals, a machine learning model configuration and machine learning model parameters, wherein each of the selected UE terminals is configured to: execute the machine learning model, receive the machine learning model configuration and machine learning model parameters, input, into the machine learning model, present spatiotemporal trajectory data from one or more sensors associated with the selected UE terminals, obtain, at a processor of each of the selected UE terminals, the predicted spatiotemporal trajectory of each selected UE terminal, wherein each of the selected UE terminals comprises computer-executable instructions configured to perform spatiotemporal trajectory prediction based on the received machine learning model configuration and parameters, and send, to the communications server, results of the spatiotemporal trajectory prediction, and wherein the communications server is further configured to: select a second number of the UE terminals, aggregate the spatiotemporal trajectory prediction results of the first number of the UE terminals, second determine whether the predicted spatiotemporal distance between any one pair of the first number of the UE terminals is within a proximity range, obtain a communications server notification if the second determining relates to a first one of the UE terminals belonging to one of the vehicles and a second one of the UE terminals belonging to one of the VRUs, tag the first and second UE terminals as notified UE terminals, and provide, to each of the notified UE terminals, a danger notification pertaining to road usage safety.

In some embodiments, the communications server is further configured to receive an acknowledgement of the communications server notification from the notified UE terminals.

In some embodiments, the acknowledgement is based on activating a proximity signal between the notified UE terminals.

In some embodiments, the proximity signal includes a radio frequency communications configured to be implemented with any one of IEEE 802, IEEE 802.11, or IEEE 802.15 signal protocols, or a combination thereof.

In some embodiments, at least one of the UE terminals further comprises a time-, frequency-, phase-, or polarization-based amplifier such as a positive-feedback loop amplifier, a heterodyne amplifier, a transistor-based amplifier, or any other type of electronic amplifiers.

In some embodiments, the proximity signal is configured to be generated by an interoperable system that communicates with an intelligent transportation systems (ITS)-based standard, including at least one of: dedicated short-range communications (DSRC), LTE, and cellular vehicle-to-everything (C-V2X).

In some embodiments, the communications server notification includes a duet comprising a mobile equipment identifier (MEID) of the notified UE terminal belonging to the vehicle and the MEID of the notified UE terminal belonging to the VRU.

In some embodiments, the danger notification includes an information message, a warning message, an alert message, a prescription for danger avoidance, a prescription for collision avoidance, a prescription for moral conflict resolution, a statement of local applicable road regulations, a warning for obeying road regulations, an audible message, a visual message, a haptic message, a cognitive message, any notification pertaining to road safety, or any combination thereof.

In some embodiments, the prescription for collision avoidance includes the prescription for applying brakes to slow down or to stop the vehicle through an advanced driver assistant system (ADAS) or an automated driving system (ADS) of the notified vehicle.

In some embodiments, the communications server is further configured to transmit the danger notification to a communications network infrastructure, a road traffic infrastructure, a pedestrian crosswalk infrastructure, a cloud computing server, an edge computing device, an Internet of things (IoT) device, a fog computing device, any information terminal pertaining to the field of road safety, or a combination thereof.

In some embodiments, the communications server includes any one of a location service client (LCS) server, an LTE base station server, an LTE wireless network communications server, a gateway server, a cellular service provider server, a cloud server, or a combination thereof.

In some embodiments, the UE terminals further comprise global navigation satellite systems (GNSS)-capable sensors, global positioning system (GPS)-capable sensors, microelectromechanical (MEMS) accelerometer sensors, of MEMS gyroscope sensors, or an interoperable combination thereof.

In some embodiments, the UE terminals include smartphones, Internet of things (IoT) devices, tablets, advanced driver assistant systems (ADAS), automated driving systems (ADS), any other portable information terminals, mobile terminals, or a combination thereof.

In some embodiments, the LTE uses 5G NR new radio access technology (RAT).

In some embodiments, the VRU includes non-motorized road users including one or more of: pedestrians, construction workers, emergency services workers, policemen, firefighters, bicyclists, wheelchair users; motorized road users including one or more of: scooters or motorcyclists; or persons with disabilities, reduced mobility, or orientation.

In some embodiments, the vehicles include any motor propelled device presenting a road hazard for VRUs, including: cars, autonomous vehicles, non-autonomous vehicles, self-driving vehicles, off-road vehicles, trucks, manufacturing vehicles, industrial vehicles, safety and security vehicles, electric vehicles, low-altitude airplanes, helicopters, drones, boats, or any other type of automotive, aerial, or naval vehicles with some proximity to VRUs.

Yet another inventive aspect is a method for collision avoidance between vulnerable road users (VRUs) and vehicles, the method comprising: linking, to a plurality of vehicles and to a plurality of VRUs, long-term evolution (LTE)-capable user equipment (UE) terminals having an international mobile subscriber identity (IMSI); first selecting, at a communications server, a first number of the UE terminals, wherein the first selection comprises: receiving past spatiotemporal trajectory data from one or more sensors associated with each of the selected UE terminals; storing the past spatiotemporal trajectory data of each of the selected UE terminals; first determining a machine learning model for predicting a future spatiotemporal trajectory of any one of the selected UE terminals, wherein the communications server comprises computer-executable instructions configured to perform spatiotemporal trajectory prediction and spatiotemporal crowd behavior prediction based on machine learning training; sending, to each of the selected UE terminals, a machine learning model configuration and machine learning model parameters; and causing each of the selected UE terminals to execute the machine learning model to perform: receiving the machine learning model configuration and machine learning model parameters; inputting, into the machine learning model, present spatiotemporal trajectory data from the one or more sensors associated with each of the selected UE terminals; obtaining, at a processor of each of the selected UE terminals, a predicted spatiotemporal trajectory of each selected UE terminal, wherein each of the selected UE terminals comprises computer-executable instructions configured to perform the spatiotemporal trajectory prediction based on the received machine learning model configuration and parameters; and sending, to the communications server, results of the spatiotemporal trajectory prediction; and second selecting, at the communications server, a second number of the UE terminals, wherein the second selecting comprises: aggregating the results of the spatiotemporal trajectory prediction for the selected first number of the UE terminals; second determining whether the predicted spatiotemporal distance between any one pair of the selected first number of the UE terminals is within a proximity range; obtaining a communications server notification in response to the second determining relating to a first one of the UE terminals belonging to one of the vehicles and a second one of the UE terminals belonging to one of the VRUs; tagging the first and second UE terminals as notified UE terminals; and providing, to the notified UE terminals, a danger notification pertaining to road usage safety.

In some embodiments, the second selecting further comprises receiving an acknowledgement of the communications server notification from the notified UE terminals.

In some embodiments, the acknowledgement is based on activating a proximity signal between the first and second notified UE terminals.

In some embodiments, the proximity signal includes a radio frequency communications configured to be implemented with any one of IEEE 802, IEEE 802.11, or IEEE 802.15 signal protocols, or a combination thereof.

In some embodiments, the proximity signal is configured to be generated by an interoperable system that communicates with an intelligent transportation systems (ITS)-based standard, including at least one of: dedicated short-range communications (DSRC), LTE, and cellular vehicle-to-everything (C-V2X) communications.

In some embodiments, the communications server notification includes a duet comprising a mobile equipment identifier (MEID) of the first notified UE terminal belonging to the vehicle and the MEID of the second notified UE terminal belonging to the VRU.

In some embodiments, the danger notification includes an information message, a warning message, an alert message, a prescription for danger avoidance, a prescription for collision avoidance, a prescription for moral conflict resolution, a statement of local applicable road regulations, a warning for obeying road regulations, an audible message, a visual message, a haptic message, a cognitive message, any notification pertaining to road safety, or any combination thereof.

In some embodiments, the prescription for collision avoidance includes a prescription for applying brakes to slow down or to stop the vehicle through an advanced driver assistant system (ADAS) or an automated driving system (ADS) of the notified vehicle.

In some embodiments, the proximity signal comprises the communications server notification and the danger notification.

In some embodiments, providing the danger notification further comprises transmitting the danger notification to a communications network infrastructure, a road traffic infrastructure, a pedestrian crosswalk infrastructure, a cloud computing server, an edge computing device, an Internet of things (IoT) device, a fog computing device, any information terminal pertaining to the field of road safety, or a combination thereof.

In some embodiments, the communications server includes any one of a location service client (LCS) server, an LTE base station (BS) server, an LTE wireless network communications server, a gateway server, a cellular service provider server, a cloud server, or a combination thereof.

In some embodiments, the UE terminals further comprise global navigation satellite systems (GNSS)-capable sensors, global positioning system (GPS)-capable sensors, microelectromechanical (MEMS) accelerometer sensors, of MEMS gyroscope sensors, or an interoperable combination thereof.

In some embodiments, the UE terminals include smartphones, Internet of things (IoT) devices, tablets, advanced driver assistant systems (ADAS), automated driving systems (ADS), any other portable information terminals, mobile terminals, or a combination thereof.

In some embodiments, the machine learning model includes a dead reckoning algorithm, an artificial intelligence algorithm, a recurrent neural network (RNN) algorithm, a reinforcement learning (RL) algorithm, a conditional random fields (CRFs) algorithm, or a combination thereof.

In some embodiments, the communications server is configured to train the machine learning model using a set of spatiotemporal trajectory data comprising position, speed, acceleration, and/or direction components, or a combination thereof, of any one of the UE terminals.

In some embodiments, the processor of each of the selected UE terminals is configured to execute the machine learning model using model configuration and model parameters.

Still yet another inventive aspect is a system for collision avoidance between vulnerable road users (VRUs) and vehicles, the system comprising: a communications server comprising computer-executable instructions configured to perform spatiotemporal trajectory prediction and spatiotemporal crowd behavior prediction based on machine learning training, the communications server configured to: select a first number of long-term evolution (LTE)-capable user equipment (UE) terminals having an international mobile subscriber identity (IMSI), wherein each of the UE terminals is linked to a vehicle or a VRU; receive past spatiotemporal trajectory data from one or more sensors associated with each of the selected UE terminals; store the past spatiotemporal trajectory data of each of the selected UE terminals; first determine a machine learning model for predicting a future spatiotemporal trajectory of any one the selected UE terminals; send, to each of the selected UE terminals, a machine learning model configuration and machine learning model parameters; cause each of the selected UE terminals to: execute the machine learning model; receive the machine learning model configuration and machine learning model parameters; input, into the machine learning model, present spatiotemporal trajectory data from one or more sensors associated with the selected UE terminals; obtain, at a processor of each of the selected UE terminals, the predicted spatiotemporal trajectory of each selected UE terminal, wherein each of the selected UE terminals comprises computer-executable instructions configured to perform spatiotemporal trajectory prediction based on the received machine learning model configuration and parameters; and send, to the communications server, results of the spatiotemporal trajectory prediction, the communications server further configured to: select a second number of the UE terminals; aggregate the results of the spatiotemporal trajectory prediction for the selected first number of the UE terminals; second determine whether the predicted spatiotemporal distance between any one pair of the first number of the UE terminals is within a proximity range; obtain a communications server notification in response to the second determining relating to a first one of the UE terminals belonging to one of the vehicles and a second one of the UE terminals belonging to one of the VRUs; tag the first and second UE terminals as notified UE terminals; and provide, to each of the notified UE terminals, a danger notification pertaining to road usage safety.

In some embodiments, the communications server is further configured to receive an acknowledgement of the communications server notification from the notified UE terminals.

In some embodiments, the acknowledgement is based on activating a proximity signal between the notified UE terminals.

Yet another inventive aspect is a non-transitory computer readable medium, having stored thereon instructions that, when executed by a processor, cause the processor to: link, to a plurality of vehicles and to a plurality of VRUs, long-term evolution (LTE)-capable user equipment (UE) terminals having an international mobile subscriber identity (IMSI); first select, at a communications server, a first number of the UE terminals, wherein the first selection comprises: receiving past spatiotemporal trajectory data from one or more sensors associated with each of the selected UE terminals; storing the past spatiotemporal trajectory data of each of the selected UE terminals; first determining a machine learning model for predicting a future spatiotemporal trajectory of any one of the selected UE terminals, wherein the communications server comprises computer-executable instructions configured to perform spatiotemporal trajectory prediction and spatiotemporal crowd behavior prediction based on machine learning training; sending, to each of the selected UE terminals, a machine learning model configuration and machine learning model parameters; and causing each of the selected UE terminals to execute the machine learning model to perform: receiving the machine learning model configuration and machine learning model parameters; inputting, into the machine learning model, present spatiotemporal trajectory data from the one or more sensors associated with each of the selected UE terminals; obtaining, at a processor of each of the selected UE terminals, a predicted spatiotemporal trajectory of each selected UE terminal, wherein each of the selected UE terminals comprises computer-executable instructions configured to perform the spatiotemporal trajectory prediction based on the received machine learning model configuration and parameters; and sending, to the communications server, results of the spatiotemporal trajectory prediction; and second select, at the communications server, a second number of the UE terminals, wherein the second selecting comprises: aggregating the results of the spatiotemporal trajectory prediction for the selected first number of the UE terminals; second determining whether the predicted spatiotemporal distance between any one pair of the first number of the UE terminals is within a proximity range; obtaining a communications server notification in response to the second determining relating to a first one of the UE terminals belonging to one of the vehicles and a second one of the UE terminals belonging to one of the VRUs; tagging the first and second UE terminals as notified UE terminals; and providing, to the notified UE terminals, a danger notification pertaining to road usage safety.

Any of the features of an aspect is applicable to all aspects identified herein. Moreover, any of the features of an aspect is independently combinable, partly or wholly with other aspects described herein in any way, e.g., one, two, or three or more aspects may be combinable in whole or in part. Further, any of the features of an aspect may be made optional to other aspects. Any aspect of a method can comprise another aspect of a system for collision avoidance between vulnerable road users (VRUs) and vehicles, and any aspect of a system for collision avoidance between vulnerable road users (VRUs) and vehicles can be configured to perform a method of another aspect. Furthermore, any aspect of a method can comprise another aspect of at least one of a cloud, a server, an infrastructure device, a vehicle, a VRU terminal or a vehicle terminal, and any aspect of a cloud, a server, an infrastructure device, a vehicle, a VRU terminal or a vehicle terminal can be configured to perform a method of another aspect.

### BRIEF DESCRIPTION OF THE DRAWINGS

FIG. 1 illustrates a flow diagram related to a method and a system for collision avoidance between VRUs and vehicles as a distributed AI among edge and cloud systems.

FIG. 2 illustrates one embodiment of a task distribution for the method of collision avoidance between VRUs and vehicles, wherein the task distribution relates to a distributed AI among edge and cloud systems.

FIG. 3 illustrates one embodiment of a task distribution for the method for collision avoidance between VRUs and vehicles, wherein the task distribution is configured as an interconnected system comprising edge and cloud nodes, wherein the VRU is moving across a wireless network comprising intelligent transportation systems (ITS)-based standards, including dedicated short-range communications (DSRC) or cellular vehicle-to-everything (C-V2X) PC5 networks, and wherein the communications configuration relates mostly to local (edge) wireless communications infrastructure.

FIG. 4 illustrates one embodiment of a task distribution for the method for collision avoidance between VRUs and vehicles, wherein the task distribution is configured as an interconnected system comprising edge and cloud nodes, and wherein the VRU is not moving.

FIG. 5 illustrates one embodiment of a task distribution for the method of collision avoidance between VRUs and vehicles, wherein the task distribution is configured as an interconnected system comprising edge and cloud nodes, wherein the VRU is moving across a wireless network comprising ITS-based standards, including LTE, LTE-M and C-V2X Uu cellular networks, and wherein the communications configuration relates mostly to cellular wireless communications infrastructure.

FIG. 6 illustrates one embodiment of a task distribution for the method for collision avoidance between VRUs and vehicles, wherein the task distribution is configured as an interconnected system comprising edge and cloud nodes, and wherein the VRU is not moving or is distal to the road.

FIG. 7 illustrates one embodiment of a telecommunication structure for collision avoidance between VRUs and vehicles, wherein the method comprises an interconnected communications system between edge and cloud nodes, configured to any one of IEEE 802, or IEEE 802.11, or IEEE 802.15 signal protocols, or a combination thereof.

FIG. 8 illustrates one embodiment of the method for collision avoidance between VRUs and vehicles, wherein the method comprises a set of rules for providing a danger notification that may relate to a proximity range shaped like an ellipse.

FIG. 9 illustrates one embodiment of the method for collision avoidance between VRUs and vehicles, wherein the method comprises a set of rules for providing a danger notification that may relate to a proximity range shaped like an ensemble of n concatenated ellipses, and wherein smaller ellipses relate to higher risks in collision-probability assessments.

FIG. 10 illustrates an LTE-capable UE terminal having an international mobile subscriber identity (IMSI), that may be linked to a vehicle or to a CRU (such as a mobile phone inserted in the pocket of the VRU or attached to the dashboard of the vehicle), and that may comprise an internally-integrated or externally-attached computational unit or processor (hardware, firmware, and/or software) for processing an AI algorithm, the computational unit being one of: a mobile application, a software, a firmware, a hardware, a physical device, and a computing device, or a combination thereof.

FIG. 11 illustrates an example flowchart for a process to be performed by a notified UE terminal linked to a vehicle, according to an embodiment of the described technology; such a block diagram being enabled at the notified UE terminal if a communications server notification is received from the communication server, and if a danger notification is received from the UE terminal linked to the corresponding notified VRU.

### DETAILED DESCRIPTION OF CERTAIN INVENTIVE EMBODIMENTS

The amount of data that mobile terminals collect is rapidly increasing. Consequently, powering more intelligent applications in practice is often impossible on a single node, as merely storing the whole dataset on a single node becomes infeasible. This necessitates the use of a distributed computational framework, in which the training data describing the problem is stored in a distributed fashion across a number of interconnected nodes and the optimization problem is solved collectively by the cluster of nodes. Loosely speaking, one can use any network of nodes to simulate a single powerful node, on which one can run any algorithm. The practical issue is that the time it takes to communicate between a processor and memory on the same node is normally many orders of magnitude smaller than the time needed for two nodes to communicate; similar conclusions hold for the energy required. Further, in order to take advantage of parallel computing power on each node, it is necessary to subdivide the problem into subproblems suitable for independent/parallel computation. State-of-the-art optimization algorithms are typically inherently sequential. Moreover, they usually rely on performing a large number of very fast iterations. The problem stems from the fact that if one needs to perform a round of communication after each iteration, practical performance drops down dramatically, as the round of communication is much more time-consuming than a single iteration of the algorithm.

The use of a distributed computational framework, in which the training data describing the problem is stored in a distributed fashion across a number of interconnected nodes, may be implemented in the context of distributed AI among edge and cloud systems. In such distributed AI, cloud systems may be charged with computationally intensive applications, and edge systems may be charged with low-latency, time-critical, low-energy, and low-data consuming applications, such that the optimization problem is solved collectively and efficiently (time-wise, energy-wise and data-wise) by the cluster of interconnected edge and cloud nodes. Collision avoidance between VRUs and vehicles may benefit from such a distributed AI among edge and cloud systems. As ‘collision avoidance’ relates to the field of road safety, collision avoidance between VRUs and vehicles requires providing “danger notifications” to VRUs and to nearby approaching vehicles. The danger notifications may be triggered according to a set of rules that take into account VRUs and vehicles past, current, and predicted trajectories, as well as proximity threshold limits for danger avoidance between VRUs and vehicles. The usefulness of providing danger notifications relates to the field of road safety since accidents between pedestrians and vehicles occur on a daily basis, and human injury can be severe enough that VRUs may be injured or killed by vehicular traffic, and thus VRUs and vehicles must observe their respective traffic rules. To be useful, danger notifications relating to the field of road safety may require timely notification, or precautious triggering, in order to let VRUs and vehicles have sufficient lead time to react, such as to correct a road usage offence, or to actively prepare to prevent the danger before an accident occurs. For most road circumstances, lead time to react may correspond to providing danger notifications provided to VRUs and vehicles at least 5 seconds in advance, Of more. Therefore, algorithms configured to compute ‘predicted trajectories’ of VRUs and vehicles may be useful in achieving such timely notifications, wherein predictions may be based on modern signal processing of spatiotemporal trajectories including dead reckoning techniques and AI, Accordingly, some embodiments provide a method and system for distributed predictive VRU-to-vehicle collision avoidance and for providing danger notifications to the VRUs and to nearby approaching vehicles for the sake of collision avoidance, wherein the danger notifications are triggered according to a set of rules that take into account VRUs and vehicles past, current, and predicted trajectories.

Each year, about 1.35 million people worldwide die from vehicle-related accidents, and more than half of these victims are VRUs (e.g., pedestrians, bicyclists, motorcyclists). As autonomous vehicles become an increasing presence on roadways, there is growing concern about how everyone will share the road safely. Various embodiments of the present disclosure aim to minimize the risks of accidents with vehicles: cars and trucks, buses, autonomous vehicles, construction equipment, drones, etc. Some embodiments provide an AI-enabled method and system that can create a virtual protection zone around pedestrians, wheelchair users, cyclists, and/or motorcyclists using their mobile devices. Some embodiments provide a method and system that can send the VRU position coordinates to all nearby connected vehicles, augmenting the vehicles' sensor input to ensure the VRU is recognized and tracked. In some embodiments, if a connected vehicle gets too close to a VRU, its brakes will be triggered automatically before a collision can occur.

Various embodiments provide a method and a system for collision avoidance between VRUs and vehicles as a distributed AI among edge and cloud systems, and for providing danger notifications to the VRUs and to nearby approaching vehicles for the sake of collision avoidance with sufficient lead time to react.

The described technology relates to a method and a system for collision avoidance between VRUs and vehicles, and more specifically for P2V collision avoidance, in the field of intelligent transportation technology and data analytics with an AI algorithm distributed among edge and cloud systems. The distribution of data analytics is weighted between edge and cloud systems: the cloud system referring to a neural network computational algorithm embedded in a distant server, and the edge system referring to a UE mobile terminal exhibiting a P2V collision avoidance applicative algorithm. One non-limiting advantage of the described technology is for providing P2V danger notifications relating to the field of road safety, and pertaining to collision avoidance, before accidents happen. The described technology relates to precautions collision avoidance notifications using past, current and predicted trajectories of VRUs and vehicles, based on an AI algorithm distributed among edge and cloud systems.

As used herein, the term ‘vulnerable road user’, Of ‘VRU’, generally refers to any human being that has to be protected from road hazards. The term includes but is not limited to: non-motorized road users such as pedestrians, construction workers, emergency services workers, policemen, firefighters, bicyclists, wheelchair users, and/or motorized road users such as scooters, motorcyclists, or any other VRUs or persons with disabilities and/or reduced mobility and orientation. Also, as used herein, the term ‘vehicle’ generally refers to any motor propelled device that could present a road hazard for VRUs. It includes but is not limited to: cars, autonomous vehicles, non-autonomous vehicles, self-driving vehicles, off-road vehicles, trucks, manufacturing vehicles, industrial vehicles, safety and security vehicles, electric vehicles, low-altitude airplanes, helicopters, drones (UAVs), boats, or any other types of automotive, aerial, and/or naval vehicles with some proximity to VRUs such as encountered in urban, industrial, commercial, airport, and/or naval environments.

A method for collision avoidance between two entities requires the knowledge of their respective spatiotemporal positioning. As used herein, the term ‘spatiotemporal positioning’ generally refers to the position coordinates of an entity of interest determined with both spatial and temporal quantities. The current spatiotemporal positioning of a VRU may be determined from LTE cellular radio signals mediated by cellular base stations (BS) and a location service client (LCS) server. With such technique, signals from at least three cellular BSs may be used to determine by triangulation the position of a VRU if an LTE-capable mobile terminal is physically linked to the VRU, such as a mobile phone inserted in the pocket of the VRU or held by the VRU, attached to the dashboard of the vehicle, or disposed somewhere inside the vehicle (e.g., UE terminal that belongs to a driver of the vehicle). Also, the current spatiotemporal positioning of a VRU may be determined from other types of sensors including, for example, any one of global positioning system (GPS) sensors, global navigation satellite systems (GNSS) sensors, or microelectromechanical system (MEMS) accelerometer sensors, of MEMS gyroscope sensors, embedded in the mobile terminal of the VRU. Also, the current spatiotemporal positioning of a VRU may be determined from the interoperability of several different positioning sensors, wherein the current spatiotemporal positioning data may be obtained using a combination of different sensors, and/or obtained by switching from one sensor to another, depending on the signal strength and/or signal availability at a given position. As used herein, the term “interoperability” generally refers to the capability of different sensors embedded within a same terminal to work at the same time, to exchange data to a processor via a common set of exchange formats and file formats, and/or to use the same protocols. For example, GPS signal strength may be unavailable in dense urban areas, whereas LTE signal may be used for spatiotemporal positioning in such circumstances. Also, for example, LTE signal strength may be unavailable in rural areas, whereas GPS signal may be used for spatiotemporal positioning in such circumstances. Also, for example, if GPS- or LTE-signals are unavailable (within road tunnels for example) other sensors exhibiting speed, accelerometry, and/or gyroscopic sensing capabilities may be used to complement spatiotemporal positioning information in such circumstances, Therefore, the method for collision avoidance between two entities may use sensor interoperability within the mobile terminal of the VRU (as well as within the mobile terminal of the vehicle) in order to maximize spatiotemporal data acquisition under various circumstances.

However, obtaining a precise measure of the spatiotemporal trajectory can be very challenging if using only current spatiotemporal positioning data, as the spatiotemporal positioning offered by GPS- or LTE-capable terminals may be highly inaccurate. The global system for mobile communications (GSM)/code-division multiple access (CDMA)/LTE mobile terminal triangulation tracking technique typically does not exhibit sufficient spatial resolution in most sub-urban areas as to ascertain spatiotemporal positioning within tens of meters accuracy. LTE using 5G new radio (NR) access technology (RAT) developed by the 3rd generation partnership project (3GPP) for 5G mobile networks may improve mobile terminal triangulation tracking techniques within a few meters accuracy. As for GPS/GNSS sensors embedded in mobile terminals, spatiotemporal positioning inaccuracies may be about 5 meters or more, which may not be accurate enough to positively ascertain collision probability between a VRU and a vehicle. Furthermore, the techniques of map-matching VRUs and vehicles onto digital road maps may not be accurate enough to positively ascertain collision probability since road maps often do not include precise path widths, crossing walk locations, and/or updates of paths marked for VRU exclusive use. As a result, using only current spatiotemporal positioning data, and/or simply matching the current spatiotemporal positioning to road maps, may yield inaccurate results, meaning a high occurrence of false positives and/or false negatives for the determination of collision probability.

The spatiotemporal positioning accuracy of GPS- or LIE-capable terminals may be improved by taking into account past and current spatiotemporal positioning data points and by signal processing of the data points, such as with a Kalman filter, and/or other signal filtering techniques, that averages past and current spatiotemporal data points using specific models in order to reduce data noise. Road maps inaccuracies may be improved by storing past spatiotemporal trajectory data of vehicles and VRUs in order to determine their respective likely road usage paths based on statistical techniques.

The predicted spatiotemporal positioning of a VRU may be determined from modern signal processing techniques applied to past and current spatiotemporal data points of a VRU, including dead reckoning techniques and AI techniques. Past and current speed, acceleration, and direction data points may also be used, in addition to spatiotemporal position data points, in order to enhance prediction accuracy and reliability. Therefore, in addition to GPS- or LTE-capable terminals, other terminals exhibiting speed, accelerometry and gyroscopic sensing capabilities may be useful.

In the dead reckoning technique, the process of predicting spatiotemporal positioning includes calculating a VRUs future position by using past and current positions, as well as estimations of speed, acceleration and direction over elapsed time. The dead reckoning technique may use a Kalman filter based on the Newton's laws of motion, wherein the filtering is based on position, speed, acceleration, and/or direction data. With such technique, the position and speed can be described by the linear state space Xₖ={X dX/dt}′, where dX/dt is the speed, that is, the derivative of the three-dimensional position X=ƒ(x,y,z) with respect to time. It can be assumed that between the (k-l) and k timestep uncontrolled forces cause a constant acceleration of aₖ that is normally distributed, with mean 0 and standard deviation σₐ. From Newton's laws of motion, the signal filtering on the spatiotemporal positioning Xₖ may take the following analytical form: Xₖ=F Xₖ₋ₗ=G aₖ, where F={1 [symbol] t, 0 1} and G={ [symbol] t²/2 [symbol] t²}.

In the AI technique, the process of predicting spatiotemporal positioning includes embedding a recurrent neural network (RNN) algorithm, a reinforcement learning (RL) algorithm, a conditional random fields (CRFs) algorithm, a machine learning algorithm, a deep learning algorithm, any other AI algorithm, or a combination thereof. RNN is an artificial neural network algorithm where connections between nodes form a directed graph along a temporal sequence, this allows the neural network to exhibit a temporal dynamic behavior in which the spatiotemporal coordinates of a VRU is denoted by a matrix X=(x,y,z,t). RL is an area of machine learning concerned with how participants ought to take actions in an environment so as to maximize some notion of cumulative reward. CRF is a class of statistical modeling method often applied in pattern recognition and machine learning and used for structured prediction.

The AI algorithms may be used to predict the likely trajectory of a VRU based on small spatiotemporal data sets as well as large spatiotemporal data sets. A spatiotemporal trajectory model may be defined as a set of spatiotemporal points X=(x,y,z,t) of a participant moving along a trajectory represented by its geolocation coordinates in space and time (sequential datasets of participant, time and location). The data sets may also be spatiotemporal geolocation data that may comprise other types of data not classified as spatiotemporal points, such as speed data, acceleration data, direction data, and/or other types of data. In order to process sequential datasets, neural networks of deep learning (e.g., RNNs) algorithms may be used. RNNs have been developed mostly to address sequential or time-series problems such as sensor's stream data sets of various length. Also, long short term memory (LSTM) algorithms may be used, which mimics the memory to address the shortcomings of RNN due to the vanishing gradient problems, preventing the weight (of a given variable input) from changing its value. RNN is an artificial neural network with a hidden layer hₜ, referring to a recurrent state and representing a “memory” of the network through time. The RNN algorithm may use its “memory” to process sequences of inputs xₜ. At each time step t, the recurrent state updates itself using the input variables xₜ and its recurrent state at the previous time step hₜ₋₁, in the form: hₜ=ƒ(xₜ,hₜ₋₁). The function ƒ(xₜ,hₜ₋₁) in turn is equal to g(Wψ(xₜ)+Uhₜ₋₁+bh), where ψ(xt) is the function which transforms a discrete variable into a continuous representation, while W and U are shared parameters (matrices) of the model through all time steps that encode how much importance is given to the current datum and to the previous recurrent state. Variable b is a bias, if any. Whereas neural networks of deep learning models require large data sets to learn and predict the trajectory of a participant, CRFs may be used for the same purpose for smaller data sets. CRFs may be better suited for small datasets and may be used in combination with RNN. Models with small datasets may use RL algorithms when trajectory predictions consider only nearest spatiotemporal geolocation data.

The AI algorithms may be used to predict a likely trajectory based on expanded spatiotemporal data sets and other type of data sets, which may relate to the trajectory intent of a vehicle or a VRU, including spatiotemporal velocity and acceleration data sets that determine spatiotemporal change of position (dx/dt, dy/dt, dz/dt, d²x/dt², d²y/dt², d²z/dt²), spatiotemporal angular, gyroscopic data sets that determine spatiotemporal orientation and change of orientation (θₓ, θ_{y}, θ_{z}, dθₓ/dt, dθ_{y}/dt, dθ_{z}/dt, d²θₓ/dt², d²θ_{y}/dt², d²θ_{z}/dt²), other spatiotemporal data sets, and/or a combination thereof. A spatiotemporal trajectory model may be defined as a set of spatiotemporal points X=(x, y, z, t) or a set of expanded spatiotemporal points X=(x, y, z, t, dx/dt, dy/dt, dz/dt, d²x/dt², d²y/dt², d²z/dt², θₓ, θ_{y}, θ_{z}, dθₓ/dt, dθ_{y}/dt, dθ_{z}/dt, d²θₓ/dt², d²θ_{y}/dt², d²θ_{z}/dt²) of a vehicle or a VRU moving along a trajectory represented by its geolocation, velocity, and gyroscopic coordinates in three-dimensional space and time. The RNN algorithm may use its “memory” to process sequences of inputs X=(x, y, z, t, dx/dt, dy/dt, dz/dt, d²x/dt², d²y/dt², d²z/dt², θₓ, θ_{y}, θ_{z}, dθₓ/dt, dθ_{y}/dt, dθ_{z}/dt, d²θₓ/dt², d²θ_{y}/dt², d²θ_{z}/dt²). At each time step t, the recurrent state updates itself using the input variables X, and its recurrent state at the previous time step hₜ₋₁, in the form: hₜ=ƒ(Xₜ,hₜ₋₁).

The dead reckoning and AI techniques may also be used to determine the size, area, and shape of a vehicle-to-VRU proximity threshold limit, which determines a dimensional safety margin for the VRU to establish a safe distance between the VRU and a vehicle. The vehicle-to-VRU proximity threshold limit may be based on mapping zones, e.g., regions of the environment based on a level of risk probability of identified spaces. For example, spatial coordinates coincident with sidewalks may be classified as low-danger zones for VRUs. Spatial coordinates coincident with streets may be classified as high-danger zones for VRUs. Spatial coordinates coincident with parks may be considered as safe zones for VRU. Since sidewalks represent safe zones for VRUs, the proximity threshold limit for a VRU walking on a sidewalk may be set to the size of the sidewalk itself (usually less than 3 meters). Whereas, as streets represent dangerous zones for VRUs, the proximity threshold limit may be set to a larger size (about 3 meters to about 5 meters) taking into account past, current, and/or predicted trajectories of VRU and vehicles in order to determine a dimensional safety margin for providing danger notifications with sufficient lead time to react. Also, the vehicle-to-VRU proximity threshold limit may be based on a personal VRU safety assessment, wherein for example a construction worker may accept about 3 meters as being a safe distance range to a high-speed passing vehicle whereas a pedestrian may accept about 5 meters as being a safe distance range to the same passing high-speed vehicle under the same road circumstances. Therefore, the proximity threshold limit may relate to a VRU-specific safety figure that may be inputted as an application parameter (based on personal acceptability) in the UE terminal belonging to the VRU and/or the vehicle. Also, the proximity threshold limit may relate to an acceptability safety figure based on equilibrium theory (such as Nash equilibrium points) that may be inputted as situation-specific parameter (based on local road conditions and regulations) from the cloud to the UE terminal belonging to the VRU and/or the vehicle. Other computational definition for the proximity threshold limit may be used.

According to some embodiments of the described technology, the method for processing sequences of inputs X=(x, y, z, t, dx/dt, dy/dt, dz/dt, d²x/dt², d²y/dt², d²z/dt², θₓ, θ_{y}, θ_{z}, dθₓ/dt, dθ_{y}/dt, dθ_{z}/dt, d²θₓ/dt², d²θ_{y}/dt², d²θ_{z}/dt²) may use sensor interoperability within the mobile terminal of a VRU, as well as within the mobile terminal of a vehicle, in order to maximize spatiotemporal data acquisition and/or coverage under various adverse local circumstances. For example, the extended set of spatiotemporal positioning of a VRU may be determined from the interoperability of several different positioning sensors embedded within the UE terminals, wherein the spatiotemporal positioning data may be obtained using a combination of different sensors (e.g., GPS, LTE, MEMS accelerometers, MEMS gyroscopes, etc.), or obtained by switching from one sensor to another, depending on the signal strength, and/or signal availability at a given spatiotemporal position. For example, GPS signal strength may be unavailable in dense urban areas, whereas LTE signal may be used for spatiotemporal positioning in such circumstances. Also, for example, LTE signal strength may be unavailable in rural areas, whereas GPS signal may be used for spatiotemporal positioning in such circumstances. Also, for example, GPS- or LIE-signals may be unavailable within road tunnels, whereas other interoperable sensors embedded within the UE terminals exhibiting speed, accelerometry and gyroscopic sensing capabilities may be used in order to complement spatiotemporal positioning data in such circumstances.

The AI algorithm embedded in the UE terminals or in the infrastructure terminals may be specific to terminals physically linked to a vehicle, or to terminals physically linked to a pedestrian. For example, the UE terminals physically linked to a vehicle or to a pedestrian may comprise a computational unit or processor (hardware, or firmware, or software) for processing an AI algorithm, the computational unit being one of: a mobile application, a software, a firmware, a hardware, a physical device, a computing device, or a combination thereof. The AI algorithm may use different algorithmic codes in order to provide specific results for different UE terminals, to provide specific results for different end users, who may be related to the automobile sector, to the cell phone sector, to the telecommunications sector, to the transportation sector, and/or to any other sectors. End users may include automobile original equipment manufacturers (OEMs), cell phone applications providers, mobile telephony providers, and/or any other end users.

According to some embodiments of the described technology, a method for determining (e.g., predicting) the spatiotemporal trajectory of VRUs and vehicles may comprise: linking, to a plurality of vehicles, as well as to a plurality of VRUs, LTE-capable UE terminals having an IMSI. The method may further include applying AI algorithms to predict a likely trajectory for each of the UE terminals based on spatiotemporal data sets, as one or more sensors associated with each UE terminal may provide for past and current spatiotemporal positioning data. According to some embodiments of the described technology, the LTE-capable UE terminals may use 5G NR new RAT developed by 3GPP for 5G mobile networks.

The current spatiotemporal positioning of a VRU or of a vehicle may be determined from LTE cellular radio signals mediated by cellular BSs and a LCS server. Signals from at least three cellular BSs may be used to determine by triangulation the position if an LTE-capable mobile terminal is physically linked to the VRU or to the vehicle, such as a mobile phone inserted in the pocket of the VRU, attached to the dashboard of the vehicle or disposed somewhere inside the vehicle (e.g., UE terminal that belongs to a driver of the vehicle). Also, the current spatiotemporal positioning of a VRU or of a vehicle may be determined from other types of sensors including, for example, any one of GNSS-capable sensors, GPS-capable sensors, MEMS accelerometer sensors, of MEMS gyroscope sensors, or an interoperable combination thereof, embedded in the mobile terminal. As used herein, the terms ‘UE terminal’ and ‘mobile terminal’ generally refer to a device or functionality which provides the capabilities for user applications, e.g., telephony, including the user interface.

According to some embodiments of the described technology, a method for determining, or predicting, the spatiotemporal trajectory of VRUs and vehicles may comprise: first selecting, at a communications server, a first number of the UE terminals. The first selection can comprise receiving past spatiotemporal trajectory data from one or more sensors associated with each of the selected UE terminals; storing the past spatiotemporal trajectory of each of the selected UE terminals; and first determining a machine learning model for predicting the future spatiotemporal trajectory of any one of the selected UE terminals. The communications server can comprise computer-executable instructions configured to perform spatiotemporal trajectory prediction and spatiotemporal crowd behavior prediction based on machine learning training. The method can further include sending, to each of the selected UE terminals, the machine learning model configuration and machine learning model parameters. This aspect of the described technology refers to a distributed AI among edge and cloud systems, and may more specifically refer to a distributed machine learning process among edge and cloud systems.

As used herein, the term ‘edge’ generally refers to a computing paradigm distributed to electronic peripherals that brings computation and data storage closer to the location where it is needed, to improve response times and save bandwidth. According to some embodiments of the described technology, the UE terminals linked to VRUs or to vehicles may represent edge systems as they provide computational capabilities close to the location where the computational capabilities are needed. Also, as used herein, the term ‘cloud’ generally refers to on-demand availability of computer system resources, especially data storage and computing power, without direct active management by the user. The term is generally used to describe data centers or central servers available to many users over the Internet. According to some embodiments of the described technology, the communications server may represent a cloud system as it provides extensive on-demand computational capabilities available over the Internet. According to some embodiments of the described technology, the communications server may include any one of a LCS server, an LTE BS server, an LTE wireless network communications server, a gateway server, a cellular service provider server, a cloud server, or a combination thereof. Also, as used herein, the term ‘machine learning’ generally refers to a subset of AI that relates to the study of computer algorithms that improve automatically through increasing data accumulation. Machine learning algorithms build a mathematical model (e.g., a model configuration) based on sample data (known as “training data”), in order to make predictions or decisions without being explicitly programmed to do so. As used herein, the term machine learning may also refer to the subset of supervised learning, wherein the computer (e.g., the communications server) is presented with example inputs and their desired outputs (e.g., training data), given by a predetermined model or configuration, and the goal is to learn a general rule (e.g., model configuration) that maps inputs to outputs (e.g., best-fitting model parameters). For example, in the dead reckoning technique, the model configuration may relate to Newton's laws of motion, whereas, in the AI technique, the model configuration may relate to an RNN algorithm, an RL algorithm, and/or a CRFs algorithm. The above AI algorithms are merely examples, and the described technology is not limited to these specific model configurations.

According to some embodiments of the described technology, a method for determining (e.g., predicting) the spatiotemporal trajectory of VRUs and vehicles may comprise: executing, at each of a plurality of UE terminals, the machine learning model. The executing can comprise receiving the machine learning model configuration (e.g., the functional form of the AI technique) and machine learning model parameters (e.g., the best-fitting model parameters). The executing can also include inputting, into the machine learning model, present spatiotemporal trajectory data from one or more sensors associated with each the selected UE terminals (e.g., updating the model configuration with the latest available spatiotemporal data). The executing can further include obtaining, at the processor of each of the selected UE terminals, the predicted spatiotemporal trajectory of the selected UE terminal. Each of the selected UE terminals can comprise computer-executable instructions (e.g., instructions coded in hardware, firmware, software form, or a combination thereof) configured to perform spatiotemporal trajectory prediction based on the received machine learning model configuration and parameters. The method can further include sending, to the communications server, the spatiotemporal trajectory prediction results.

The use of a distributed computational framework, in which the training data describing the problem is stored in a distributed fashion across a number of interconnected nodes, may be implemented in the context of distributed AI among edge and cloud systems. In such distributed AI, cloud systems may include computationally intensive applications, and edge systems may include low-latency, time-critical, low-energy and low-data consuming applications, such that the optimization problem is solved collectively and efficiently (time-wise, energy-wise and data-wise) by the cluster of interconnected edge and cloud nodes. According to some embodiments of the described technology, the computer-intensive operations (e.g., determining the machine learning model configuration and parameters) may be executed at a cloud system (e.g., at the communications server), whereas the time-critical non-computer-intensive operations (e.g., updating the spatiotemporal trajectory prediction with the latest available data) may be executed at an edge system (e.g., distributed over the UE terminals), such that the problem (e.g., predicting the spatiotemporal trajectory of VRUs and vehicles) is solved collectively and efficiently (e.g., time-wise, energy-wise and data-wise) by the cluster of interconnected edge and cloud nodes.

The above-mentioned method of predicting the spatiotemporal trajectory of VRUs and vehicles may be used in order to provide for a method and a system for collision avoidance between VRUs and vehicles as a distributed AI among edge and cloud systems. According to some embodiments of the described technology, a method for collision avoidance between VRUs and vehicles may comprise: selecting, at a communications server, a number of the UE terminals. The selection can comprise aggregating the spatiotemporal trajectory prediction results of a number of the UE terminals and determining whether the predicted spatiotemporal distance between any one of the number of the UE terminals is within a proximity range. The selection can also include obtaining a communications server notification if the second determining relates to a UE terminal belonging to a vehicle and a UE terminal belonging to a VRU. The selection can further include tagging these two UE terminals as notified UE terminals and providing, for each the notified UE terminals, a danger notification pertaining to road usage safety. The selecting may further comprise acknowledging, at the notified UE terminals, the communications server notification. The acknowledgement of the communications server notification may further comprise activating a proximity signal between the two notified UE terminals.

According to some embodiments of the described technology, the method for collision avoidance between VRUs and vehicles may include comparing a set of past, current, and predicted expanded spatiotemporal points X=(x, y, z, t, dx/dt, dy/dt, dz/dt, d²x/dt², d²y/dt², d²z/dt², θₓ, θ_{y}, θ_{z}, dθₓ/dt, dθ_{y}/dt, dθ_{z}/dt, d²θₓ/dt², d²θ_{y}/dt², d²θ_{z}/dt²) for a plurality of VRUs (X_{VRU}) and for a plurality of vehicles (X_{vehicle}) moving along trajectories represented by their geolocation, velocity, and gyroscopic coordinates in three-dimensional space and time. The comparison between X_{VRU} and X_{vehicle} may thus involve a wide range of possible different combinations between their respective sets of past, current, and predicted spatiotemporal points (x, y, z, t, dx/dt, dy/dt, dz/dt, d²x/dt², d²y/dt², d²z/dt², θₓ, θ_{y}, θ_{z}, dθₓ/dt, dθ_{y}/dt, dθ_{z}/dt, d²θₓ/dt², d²θ_{y}/dt², d²θ_{z}/dt²). Such range of possible different combinations may represent about n²(n+1) different combinations for comparison determinations, or about 7000 possible different combinations if 19 spatiotemporal points are considered in the expanded spatiotemporal data sets. In some embodiments, a ‘proximity range’ R may be defined by comparing the predicted spatiotemporal distance between X_{VRU}(x, y, t) and X_{vehicle}(x, y, t) at a given time t such that the difference for a given two-dimensional road-space framework is minimized, e.g., R=min|(X_{VRU}(x, y, t)−X_{vehicle}(x, y, t))|, whereas the proximity range represents the closest predicted trajectory approach between a VRU and a vehicle on a road at a future time t. In the context of road safety, the proximity range may represent a distance at which a collision-avoidance system may start to ‘look more carefully’ for a possible unsafe close approach between a VRU and a vehicle, given the intrinsic accuracy and reliability positioning limits of GPS- or LTE-capable terminals and the need to establish a safe distance between the VRU and a vehicle upon closest approach. Therefore, according to one embodiment, the method for collision avoidance between VRUs and vehicles may comprise a set of rules based on the spatiotemporal distance between X_{VRU} and X_{vehicle}, such that a proximity range R may be given by: R=min|(X_{VRU}−X_{vehicle})|.

In the context of road safety, the proximity range may be used in order to determine a dimensional safety margin for providing danger notifications with sufficient lead time to react. For the purpose of collision avoidance between VRUs and vehicles, ‘lead time to react’ may refer to the reaction time of the driver to become fully aware of the danger and to decide how and when to slow down the vehicle to prevent an accident before the accident occurs. Likewise for the VRU, ‘lead time to react’ may refer to the reaction time of a pedestrian to become fully aware of the danger and to decide how and when to move away to avoid the accident before the accident occurs. Typically, the reaction time to become fully aware of a danger is of the order of about 2 seconds, and the time required to slow down a vehicle to prevent an accident depends on its speed, and may be of the order of about 5 seconds at a speed of about 50 km/h. Therefore, a dimensional safety margin of about 20 meters or more, about 30 meters or more, and/or about 50 meters or more, depending on vehicle speed and accuracy of GPS or LTE-data, may be necessary for providing danger notifications with sufficient lead time to react, which may represent about 5 seconds or more, about 10 seconds or more, and/or about 15 seconds or more, before reaching the vehicle-to-VRU proximity threshold limit, which is a dimensional safety margin for the VRU to establish a safe distance between the VRU and a passing vehicle upon closest approach, which may represent a distance of about 3 to about 5 meters.

Therefore, according to some embodiments of the described technology, a ‘proximity range’ R may be defined by comparing the predicted spatiotemporal distance between X_{VRU}(x, y, dx/dt, dy/dt, t) and X_{vehicle}(X, y, dx/dt, dy/dt, t) at a given time t and for given speeds (dx/dt, dy/dt), such that the difference for a given two-dimensional road-space framework is minimized and is function of speed, e.g., R(x, y, dx/dt, dy/dt)=min|(X_{VRU}(x, y, dx/dt, dy/dt, t)−X_{vehicle}(x, y, dx/dt, dy/dt, t))|. The proximity range represents the closest predicted approach between a VRU and a vehicle on a road at a future time t that may be about 5 seconds or more, about 10 seconds or more, and/or about 15 seconds or more into the future. If the proximity range R is smaller than a dimensional safety margin M of about 20 meters or more, about 30 meters or more, and/or about 50 meters or more (e.g., if R<M), then the collision-avoidance system may start to ‘look more carefully’ for possible unsafe close approach between a VRU and a vehicle, and decide to provide a danger notification to the VRU and the vehicle for collision avoidance.

According to some embodiments of the described technology, the method for collision avoidance between VRUs and vehicles may comprise determining whether the proximity range R=min (X^{VRU}−X_{vehicle}) between any one of the UE terminals is smaller than a given dimensional safety margin M at a future time t. If the proximity condition (e.g., if R<M) is reached, the communications server may obtain a ‘communications server notification’ if the proximity range involves a UE terminal belonging to a vehicle and a UE terminal belonging to a VRU. The communications server may tag these two approaching UE terminals as ‘notified UE terminals’, and the communications server notification may include a duet comprising the mobile equipment identifier (MEID) of the notified UE terminal belonging to the vehicle and the MEID of the notified UE terminal belonging to the VRU. As used herein, the term ‘MEID’ generally refers to a globally unique number identifying a physical piece of mobile equipment. Depending on the closest predicted approach R between the notified VRU and the notified vehicle, and depending on their respective speeds, the communications server may provide, for each of the notified UE terminals, a danger notification pertaining to road usage safety. The danger notification may include an information message, a warning message, an alert message, a prescription for danger avoidance, a prescription for collision avoidance, a prescription for moral conflict resolution, a statement of local applicable road regulations, a warning for obeying road regulations, any notification pertaining to road safety, or any combination thereof. Also, according to some embodiments of the described technology, the danger notification may include a prescription for collision avoidance intended for the VRU (e.g., an audible message or vibrating hum warning the VRU of impending danger), and/or of a warning message intended, and sent, to the approaching vehicle (e.g., an instruction of applying brakes to slow down or to stop for vehicle). Also, according to some embodiments of the described technology, the danger notification may include any audible, visual, haptic, cognitive message, or any combination thereof, for providing a cognitive sense of urgency to the VRU upon impending danger from an approaching vehicle.

According to some embodiments of the described technology, the danger notification may include a prescription for collision avoidance including a prescription for applying brakes to slow down or to stop the vehicle through the advanced driver assistant system (ADAS) or the automated driving system (ADS) of the notified vehicle. The braking distance refers to the distance a vehicle will travel from the point when its brakes are fully applied to when it comes to a complete stop. It is primarily affected by the original speed dx/dt of the vehicle and the coefficient of friction between the tires and the road surface, and the reaction distance, which is the product of the speed and the perception-reaction time of the driver. An average perception-reaction time of tᵣ=1.5 seconds (σtᵣ=0.5 second), and an average coefficient of kinetic friction of μₓ=0.7 (σμₓ=0.15) are standard for the purpose of determining a bare baseline for accident reconstruction and judicial notice. However, a keen and alert driver may have perception-reaction times well below 1 second, and a modern car with computerized anti-skid brakes may have a friction coefficient above 0.9, thus the braking distance problem involves variances (e.g., standard deviations (σ)) for both tᵣ and μₓ. The total stopping distance Dₓ along the driving direction is the sum of the perception-reaction distance and the braking distance: Dₓ=tᵣ·dx/dt+(dx/dt)²/2μₓ g. Other measures pertaining to road safety may be included in the danger notification. Other measures pertaining to changing the vehicle direction, or swerving to avoid the VRU, may be considered as well. In this case, the total swerving distance Dₓ away from (or transversal to) the driving direction is given by the capacity of the vehicle to stay in axial control during a turn, which relates to an average lateral coefficient of kinetic friction of about μ_{y}=0.3 (σμ_{y}=0.1): D_{y}=(dy/dt)²/2μ_{y} g. Therefore, when the vehicle is notified of a danger, the danger notification may include a prescription for collision avoidance including (dx/dt)² and (dy/dt)² terms in the predicted spatiotemporal trajectory of the notified UE terminal belonging to the vehicle, which relates approximately to the shape of an ellipse if mapped on the road. Since the capacity to brake is higher than the capacity to swerve (e.g., μₓ>μ_{y}), the predicted spatiotemporal trajectory of the notified UE terminal belonging to the vehicle may exhibit a higher trajectory probability along the direction of driving in order to maintain vehicle control, and a progressively lower trajectory probability given the standard deviations (σ) for tᵣ, μₓ and, μ_{y}. Therefore, the set of rules for providing a danger notification may relate to a proximity range shaped like an ellipse, wherein the major axis of the ellipse is coincident with the predicted spatiotemporal trajectory of the notified UE terminal belonging to the vehicle, and wherein the major axis length is about 20 meters or more, about 30 meters or more, and/or about 50 meters or more. The proximity range R(x, y, dx/dt, dy/dt) may be shaped like an ellipse because vehicle control is best preserved if the driving is maintained along the vehicle trajectory.

According to some embodiments of the described technology, the dimensional safety margin M may relate to a collision-probability assessment, or a confidence factor, such that if the dimensional safety margin M is set at a small value, the probability of collision will be higher. Therefore, the proximity range R may be shaped like an ensemble of n concatenated ellipses, wherein smaller ellipses relate to higher collision-probability assessments. If the proximity condition (e.g., if R<Mₙ) is reached, the collision-probability assessments (or the confidence factor) will be progressively higher as Mₙ goes from M₁=about 50 meters, to M₂=about 30 meters, to M₃=about 20 meters, and so forth, with n scaled to a collision-probability assessment, or to a confidence factor. Other scales may be used for collision-probability assessment.

As used herein, the term “confidence factor” generally represents a range of plausible values for the collision probability between a VRU and a vehicle, computed from the statistics of the observed VRU and vehicle data. In addition to the statistics of past spatiotemporal data, the confidence factor may take into account several instrumental factors such as: the GPS accuracy of the UE terminals, the GPS swing (or GPS measurement variability), the number of available GPS/GLASS satellites signals accessed by the UE terminals, the UPS signal strength, the availability of dual frequency, the rate of data acquisition, and other instrumental factors related to the UE terminals. The confidence factor may also take into account LIE-related parameters if the spatiotemporal data is based on LTE tracking. Therefore, the proximity range R may be shaped like an ensemble of n concatenated ellipses, wherein smaller ellipses relate to higher collision-probability assessments, and wherein minor and major axis of the ellipses may depend on GPS- and/or LTE-signal strengths and data accuracies. In addition to elliptical form factors, the confidence factor may take other oblong shapes depending on local road configurations and/or local road obstacles which may impact the range of plausible values for the collision probability between a VRU and a vehicle.

According to some embodiments of the described technology, if the proximity condition (e.g., if R<M) is reached, then the method for collision avoidance between VRUs and vehicles may further comprise acknowledging, at the notified UE terminals, the communications server notification, wherein the acknowledging further comprises activating a ‘proximity signal’ between the two notified UE terminals. The proximity signal includes a radio frequency communications configured to any one of IEEE 802, IEEE 802.11, or IEEE 802.15 signal protocols, or a combination thereof. Most UE terminals based on smartphones or mobile tablets provide telephony capabilities, as well as local area network (LAN) wireless communications capabilities (e.g., wireless communications configured to IEEE 802.11 standards, e.g., WiFi), and as well as wireless personal area network (WPAN) capabilities (e.g., wireless communications configured to IEEE 802.15 standards, e.g., Bluetooth), including the user interface for setting these capabilities. In the context of proximity, time is critical, therefore the step of activating a ‘proximity signal’ between the two notified UE terminals may reduce LTE-based communications latency and may improve time-critical applications, such as exchanging locally (e.g., at the edge) the communications server notification and the providing of a danger notification for fast response in reaction to a potential danger. More broadly, the proximity signal may be configured as an interoperable edge system that enables communications between (IEEE 802)-capable UE terminals and, also, that enables communications between with ITS-based standards, including DSRC and C-V2X, which relate to local (edge) wireless communications infrastructure. As used herein, the term ‘ITS’ generally refers to traffic management applications which aim to provide road users information pertaining to the use of transport networks. The information may be provided by DSRC which are one-way or two-way short-range to medium-range wireless communication channels specifically designed for automotive use and a corresponding set of protocols and standards. The information may also be provided by the C-V2X which is a 3GPP standard describing a technology to achieve the vehicle-to-everything requirements. C-V2X is an alternative to 802.11p, the IEEE specified standard for vehicle-to-vehicle and other forms of vehicle-to-everything communications.

According to some embodiments of the described technology, the proximity signal may include a radio frequency signal comprising signal-modulation schemes for improving signal-to-noise ratio in reception and/or improving signal selectivity in reception, in order to improve signal receptivity from one emitting notified UE terminal to the other receiving notified UE terminal for which the proximity signal is intended to be communicated. According to some embodiments of the described technology, the proximity signal may include a radio frequency communications implemented with any one of IEEE 802, IEEE 802.11, or IEEE 802.15 signal protocols, or a combination thereof, and may comprise time modulation, frequency modulation, phase modulation, polarization modulation, or a combination thereof. This embodiment of the described technology may provide for an improved signal-to-noise ratio in reception (e.g., better proximity signal receptivity at the other notified UE terminal) in the context of high radio-frequency noise in urban environments at unregulated 900 MHz, 2.4 GHz, and 5.8 GHz band frequencies. According to one embodiment, the proximity signal may include a time-frequency modulation configured to direct sequence spread spectrum (DSSS), which is a spread spectrum technique whereby the original data signal is multiplied with a pseudo random noise spreading code. According to another embodiment, the proximity signal may include a time-frequency modulation configured to frequency-hopping spread spectrum (FHSS), which is a transmission technology used in LAN transmissions where the data signal is modulated with a narrowband carrier signal that “hops” in a random but predictable sequence from frequency to frequency as a function of time over a wide band of frequencies. Other time modulations, frequency modulations, phase modulations, polarization modulations, or combination thereof, may be used for the proximity signal.

At least one of the UE terminals may further comprise a time-, frequency-, phase-, and/or polarization-based amplifier such as a positive-feedback loop amplifier, a heterodyne amplifier, or any other type of amplifier. Improving proximity signal receptivity may be provided by an electronic amplifier, which is an electronic device that can increase the power of a signal (either voltage or current), such as a transistor-based amplifier such as operational amplifiers, positive-feedback amplifiers, heterodyne amplifiers, or the like.

As used herein, the term ‘positive feedback loop’ generally refers to an electronics process that occurs in a feedback loop which amplifies small input signals, and/or which provides positive gain in order to boost small signal in reception. As used herein, the term ‘heterodyne’ generally refers to a type of radio receiver that uses frequency mixing to convert a received signal to a fixed intermediate frequency which can be more conveniently processed (e.g., filtered and amplified) than the original carrier frequency. The described technology is not limited to these specific examples, and the proximity signal may be configured with an interoperable edge system that enables communications between (IEEE 802)-capable UE terminals exhibiting other types of electronics devices for improving signal-to-noise ratio and improving signal selectivity in reception.

According to one embodiment, the method for collision avoidance may further comprise transmitting the danger notification to a communications network infrastructure, to a road traffic infrastructure, to a pedestrian crosswalk infrastructure, to a cloud computing server, to an edge computing device, to an Internet of things (IoT) device, to a fog computing device, to any information terminal pertaining to the field of road safety, or to a combination thereof.

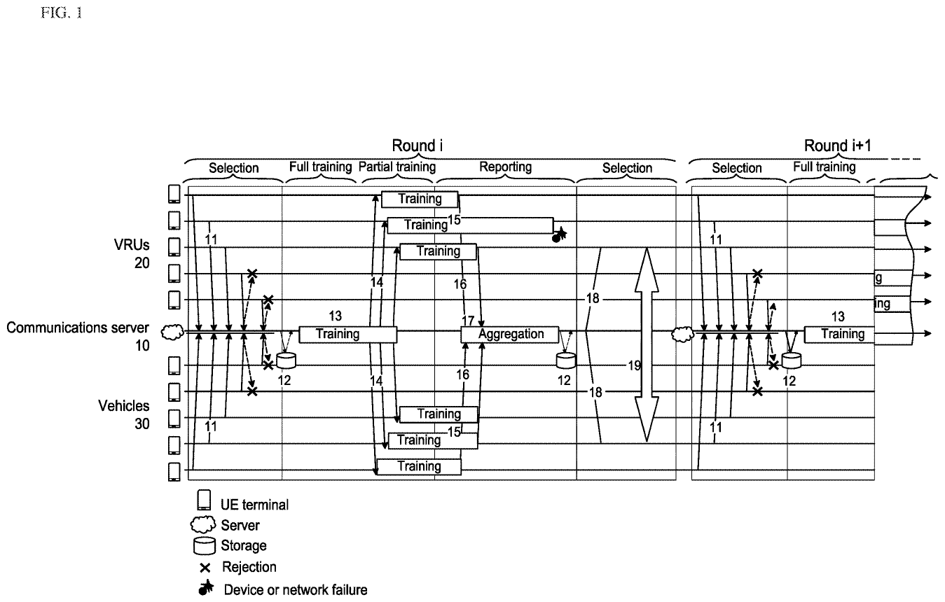

FIG. 1 illustrates a flow diagram related to a method and a system for collision avoidance between VRUs and vehicles as a distributed AI among edge and cloud systems. According to this flow diagram, the method for collision avoidance between VRUs and vehicles may comprise: linking, to a plurality of VRUs (20) and vehicles (30), LTE-capable UE terminals having an IMSI and first selecting, at a communications server (10), a first number of the UE terminals. The first selection can comprise receiving (11) past spatiotemporal trajectory data from one or more sensors associated with each of the selected UE terminals and storing (12) the past spatiotemporal trajectory of each of the selected UE terminals. The first selection may also include first determining (13) a machine learning model for predicting the future spatiotemporal trajectory of any one of the selected UE terminals. The communications server can comprise computer-executable instructions configured to perform spatiotemporal trajectory prediction and spatiotemporal crowd behavior prediction based on machine learning training.

The method can further include sending (14), to each of the selected UE terminals, the machine learning model configuration and machine learning model parameters and executing (15), at each of the selected UE terminals, the machine learning model. The executing (15) can comprise receiving (14) the machine learning model configuration and machine learning model parameters and inputting, into the machine learning model, present spatiotemporal trajectory data from one or more sensors associated with each of the selected UE terminals. The method can further include obtaining, at the processor of each of the selected UE terminals, the predicted spatiotemporal trajectory of the selected UE terminal. Each of the selected UE terminals may comprise computer-executable instructions configured to perform spatiotemporal trajectory prediction based on the received machine learning model configuration and parameters.

The method can further include sending (16), to the communications server, the spatiotemporal trajectory prediction results and then second selecting, at a communications server, a second number of the UE terminals. The second selection can comprise aggregating (17) the spatiotemporal trajectory prediction results of the first number of the UE terminals and second determining (18) whether the predicted spatiotemporal distance between any one of the first number of the UE terminals is within a proximity range. The second selection can further include obtaining a communications server notification if the second determining (18) relates to a UE terminal belonging to a vehicle and a UE terminal belonging to a VRU. The second selection can further include tagging these two UE terminals as notified UE terminals and providing, for each of the notified UE terminals, a danger notification pertaining to road usage safety. The second selecting may further comprise acknowledging, at the notified UE terminals, the communications server notification, and activating (19) a proximity signal between the two notified UE terminals.

As illustrated in FIG. 1, the method for collision avoidance between VRUs and vehicles represents a distributed AI among edge (20, 30) and cloud (10) systems, and may be updated sequentially every time a new spatiotemporal data acquisition is performed at the UE terminals (20, 30). Specifically, the method for collision avoidance between VRUs and vehicles may represent a distributed AI among edge (20, 30) systems attached to different mobile entities (e.g., pedestrians, bicycles, automobiles, trucks, etc.) and cloud (10) systems represented by fixed computational entities, and may be updated sequentially and asynchronously every time a new spatiotemporal data acquisition is performed at each and every UE terminals (20, 30).

If the method relates to an AI algorithm based on RNN algorithm, then the method may use its memory (12) within cloud systems to process sequences of spatiotemporal data inputs Xₜ. At each time step t (or Round i+1), the recurrent state updates itself using the input variables Xₜ and its recurrent state at the previous time step hₜ₋₁ (or Round i), in the form: hₜ=ƒ(Xₜ,hₜ₋₁), as explained previously.

If the method relates to an algorithm based on dead reckoning technique, then the method may use its memory (12) within cloud systems (10), the training process (15) within edge systems (20, 30), or a combination thereof, to process sequences of spatiotemporal data inputs Xₜ using a Kalman filter based on Newton's laws of motion. More generally, the method for collision avoidance between VRUs and vehicles may use various arrangements of distributed computational frameworks between edge and cloud systems, whereas the distributed computational frameworks may be synchronized (or pseudo-synchronized or asynchronized) sequentially every time a new spatiotemporal data acquisition (11) is performed at the edge, or every time a new spatiotemporal trajectory result or new machine learning update are obtained at the cloud (13) or at the edge (15).

According to one embodiment of the described technology, and still referring to FIG. 1, the method for collision avoidance between VRUs and vehicles is a distributed AI among edge and cloud systems. The machine learning technique (notably the training) is distributed between cloud (13) and edge (15) devices. The method may use various arrangements of distributed computational frameworks, in which the training data describing the problem is executed in a distributed fashion across a number of interconnected nodes (10, 20, 30). The practical issue determining this distribution among edge and cloud systems is that the time it takes to communicate between a processor and memory on the same node is normally many orders of magnitude smaller than the time needed for two nodes to communicate; similar conclusions hold for the energy required. In order to take advantage of parallel computing power on each node, it can be advantageous to subdivide the problem into subproblems suitable for the computational power, the available energy, the available bandwidth, and the data acquisition rate of UE terminals at the edge.

According to one embodiment of the described technology, and still referring to FIG. 1, the participants in this distributed computational framework are UE terminals (20, 30) (which may be smartphones) and the communications server (10) (which may be a cloud-based distributed service). UE terminals may announce to the communications server that they are ready to run a task for a given learning problem and/or application which is worked upon. The task may relate to a specific computation for a set of spatiotemporal data, such as training to be performed with given trained machine learning models for predicting VRU and vehicle trajectories. From the potential tens of thousands of UE terminals announcing availability to the communications server during a certain round time window, the communications server may select (11) a subset of a few hundred nearby UE terminals which are invited to work on a specific task at a specific road location (e.g., near an intersection or near a pedestrian roadway). These selected UE terminals stay connected to the communications server for the duration of the round.

The communications server then tells (14) the selected UE terminals what computation to run with a specific machine learning model, a data structure configuration that may include a TensorFlow graph and instructions for how to execute the TensorFlow graph. As used herein, the term ‘TensorFlow’ generally refers to an open-source software library for dataflow and differentiable programming across a range of tasks. It is a symbolic math library, and is also used for machine learning applications such as neural networks. The instructions (14) may include current global model configurations and parameters and any other necessary state as a training checkpoint, which may relate to the serialized state of a TensorFlow session. Each participant may then perform a local computation (15) based on the global state and its local dataset, and may then send (16) an update in the form of a training checkpoint back to the communications server. The communications server may then incorporate (17) and/or aggregate these updates into its global state for the sake of machine learning improvement, and the process may repeat during subsequent rounds (which may be determined by the refresh rate of GPS- or LTE-data acquisition at the edge).

According to one embodiment of the described technology, and still referring to FIG. 1, the machine learning technique is distributed between cloud (13) and edge (15) devices and may be configured as a federated learning technique. As used herein, the term ‘federated learning’ (also known as collaborative learning) generally refer to a machine learning technique that trains an algorithm across multiple decentralized edge devices or servers holding local data samples, without exchanging them. This approach stands in contrast to traditional centralized machine learning techniques where all the local datasets are uploaded to one server, as well as to more classical decentralized approaches which assume that local data samples are identically distributed. Federated learning enables multiple actors to build a common, robust machine learning model without sharing data, thus allowing to address critical issues such as data privacy, data security, data access rights and access to heterogeneous data. Federated learning also allows to address critical issues such as CPU, energy and bandwidth savings at the mobile UE terminals while keeping low-latency.

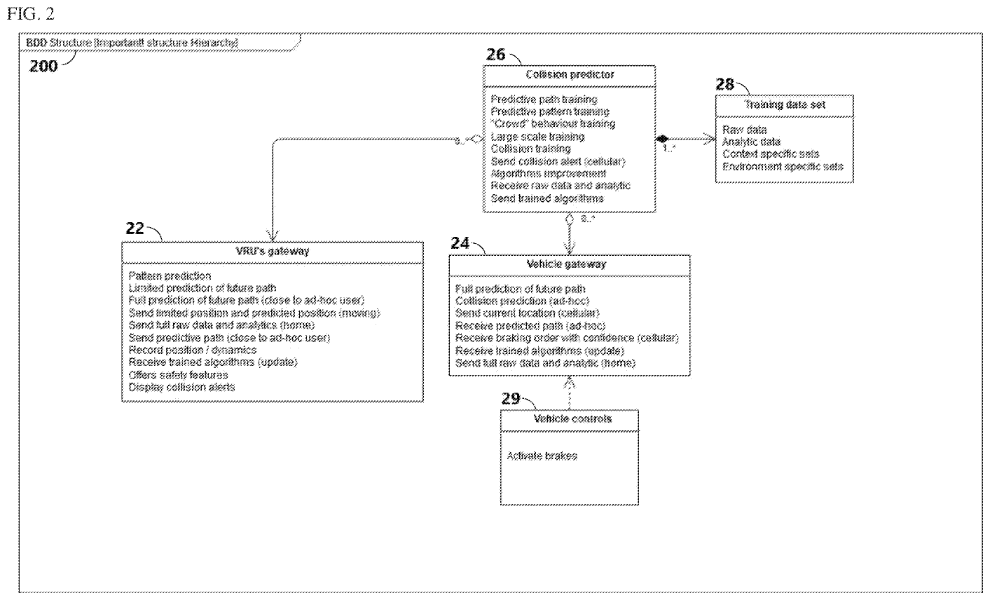

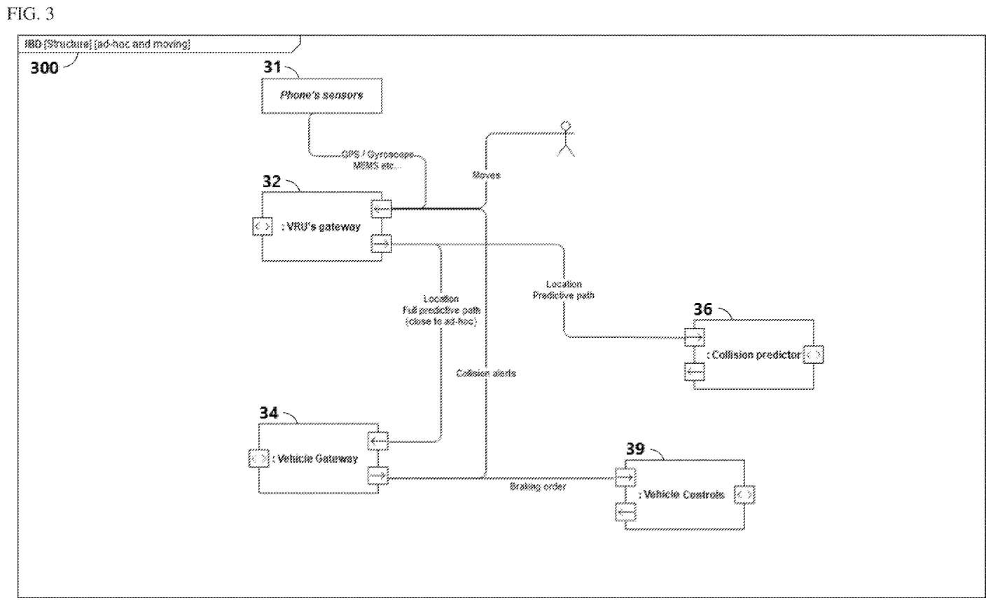

FIG. 2 illustrates one embodiment of a task distribution 200 for the method of collision avoidance between VRUs and vehicles, wherein the task distribution relates to a distributed AI among edge and cloud systems. The task distribution 200 may include a VRU's gateway 22, a vehicle gateway 24, a collision predictor 26, a training data set 28 and a vehicle control (or a vehicle controller) 29. According to one embodiment of the described technology, and referring to FIG. 2, the method for collision avoidance is a distributed AI among edge systems, comprising UE terminals linked to VRUs (20) (alternatively called VRU's gateway (22)), and UE terminals linked to vehicles (30) (alternatively called vehicle gateway (24)), and cloud systems (10) (see FIG. 1) (alternatively called the communications server, or collision predictor (26)). The task distribution 200 shown in FIG. 2 is merely an example task distribution, certain elements may be modified or removed, two or more elements combined into a single element, and/or other elements may be added. Furthermore, at least one of the elements shown in FIG. 2 may be implemented with hardware, software, firmware, or a combination thereof. This applies to the task distributions 300-600 shown in FIGS. 3-6. The VRU's gateway 22 and the vehicle gateway 24 at the edge may take charge of specific, time-sensitive, low-CPU computational tasks, whereas the collision predictor 26 at the cloud may take charge of CPU-intensive computational tasks such as machine learning training. These tasks distributed at the edge and at the cloud may refer to computer-executable tasks comprising hardware, firmware or software algorithms, or a combination thereof. According to one embodiment, CPU-intensive computational tasks such as AI algorithms based on RNN algorithms may be located within the cloud system represented by the collision predictor. According to another embodiment, low-CPU computational tasks such as algorithms based on dead reckoning techniques may be distributed within the cloud system represented by the collision predictor as well as within edge systems represented by VRU and/or vehicle gateways.

The VRU's gateway 22 can be configured to perform one or more of the following functions: pattern prediction, limited prediction of future path, full prediction of a future path (which may be close to an ad-hoc user), send limited position and prediction position (e.g., while the VRU 20 is moving), send full raw data and analytics (e.g., when the VRU 20 is at a home location), send a predictive path (which may be close to an ad-hoc user), record position and/or dynamics, receive trained algorithms (e.g., as an update), offer safety features, and display collision alerts.

The vehicle gateway 24 can be configured to perform one or more of the following functions: full prediction of a future path, collision prediction (which may be ad-hoc), send current location (e.g., via the cellular network), receive a prediction path (which may be ad-hoc), receive a braking order with a confidence value (e.g., via the cellular network), receive trained algorithms (e.g., as an update), and send full raw data and analytics (e.g., when the vehicle 30 is at a home location).

The collision predictor 26 can be configured to perform one or more of the following functions: predictive path training, predictive pattern training, “crowd” behavior training, large scale training, collision training, send collision alert (e.g., via the cellular network), algorithms improvement, receive raw data and analytics, and send trained algorithms.

The training data set 28 may be generated by the collision predictor 26 and can include one or more of the following: raw data, analytic data, context specific data, and environment specific data. The vehicle controller 29 may be configured to activate brakes of the vehicle 30 (see FIG. 1) based on the braking order received at the vehicle gateway 24. In some embodiments, the vehicle controller 29 may be configured to operate within the technological platforms provided to control autonomous or semi-autonomous vehicles, such as those related to ADAS or ADS.

FIG. 3 illustrates one embodiment of a task distribution 300 for the method for collision avoidance between VRUs and vehicles. The communications configuration of the task distribution is configured as an interconnected system comprising edge and cloud nodes. The task distribution 300 may include to phone's sensors 31, a VRU's gateway 32, a vehicle gateway 34, a collision predictor 36, and a vehicle control (or a vehicle controller) 39. The functions of the VRU's gateway 32, the vehicle gateway 34, the collision predictor 36, and the vehicle controller 39 are substantially the same as those of the corresponding blocks in FIG. 2. The VRU may be moving across a wireless network comprising ITS-based standards, including DSRC or C-V2X PC5 networks. The communications configuration can relate mostly to local (edge) wireless communications infrastructure. In this embodiment of the described technology, VRU's gateway 32 and vehicle gateway 34 at the edge may take charge of specific, time-sensitive, computational tasks, whereas the collision predictor 36 at the cloud may take charge of CPU-intensive computational tasks such as machine learning training. In this communications configuration, the interconnected system may comprise mostly edge nodes and may take advantage of the parallel computing power of each such node, where it can be advantageous to subdivide the problem into subproblems suitable for the computational power, the available energy, the available bandwidth, and the data acquisition rate of such nodes at the edge. The communications configuration of the described technology is not limited to this embodied communications configuration.

As shown in FIG. 3, when the VRU 20 moves, the VRU's gateway 32 can receive GPS, gyroscope, MEMS, and/or other sensor data from the phone's sensors 31. The VRU's gateway 32 can also receive collision alert(s) from the vehicle gateway 34. Based at least in part on the sensor data and/or the collision alert, the VRU's gateway 32 can generate a location, a predictive path, and/or a full predictive path (which may be close to ad-hoc), The collision predictor 36 may receive the location and/or the predictive path from the VRU's gateway 32, The vehicle gateway 34 can receive the location and/or full predictive path from the VRU's gateway 32 and generate the collision alert(s) and/or a braking order based at least in part on the location and/or full predictive path. The vehicle controller 39 can receive the braking order from the vehicle gateway 34 and control the vehicle to slow down or stop.

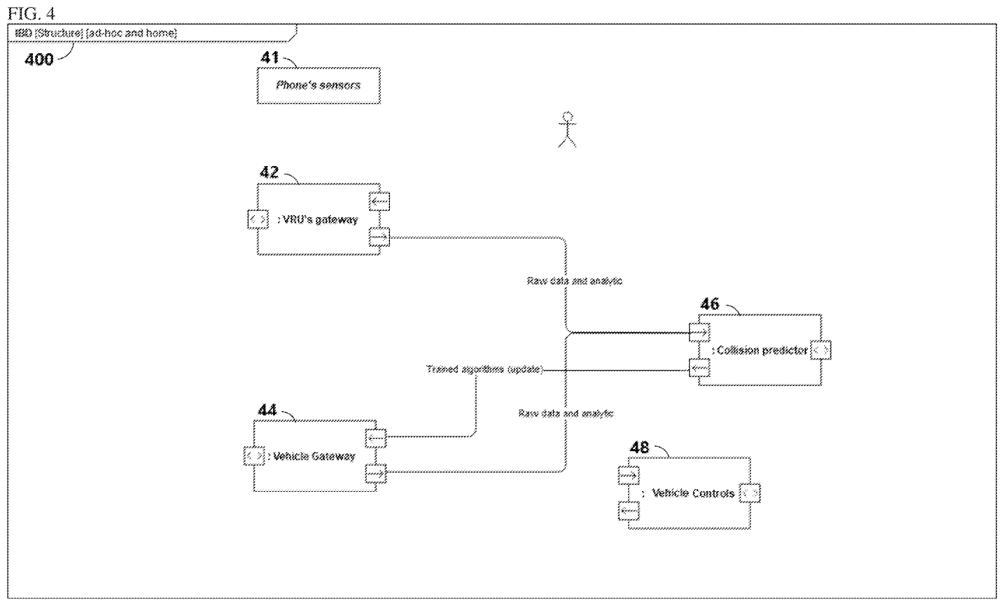

FIG. 4 illustrates one embodiment of a task distribution 400 for the method for collision avoidance between VRUs and vehicles. The task distribution 400 may include phone's sensors 41, a VRU's gateway 42, a vehicle gateway 44, a collision predictor 46, and a vehicle control (or a vehicle controller) 48. The communications configuration of the task distribution 400 is configured as an interconnected system comprising edge and cloud nodes, and wherein the VRU is not moving or is distal to a road. In this embodiment of the described technology, the VRU's gateway 42 may receive the instruction to stay idle (when it is not moving or far from a road) in order to save computational power, energy, and/or bandwidth. The vehicle gateway 44 may move and take charge of specific, time-sensitive, computational tasks. The collision predictor at the cloud may take charge of CPU-intensive computational tasks such as machine learning training.

As shown in FIG. 4, the VRU's gateway 42 can generate raw data and analytics and provide the raw data and analytics to the collision predictor 46. Based at least in part on the raw data and analytics received from the VRU's gateway 42 and/or raw data and analytics received from the vehicle gateway 44, the collision predictor 46 can generate trained algorithms (for use in an update) and provide the trained algorithms to the vehicle gateway 44. The vehicle gateway 44 can generate the raw data and analytics and provide the raw data and analytics to the collision predictor 46. The vehicle gateway 44 can further perform an update based at least in part on the trained algorithm received from the collision predictor 46.

In another embodiment of the described technology, the VRU's gateway 42 may receive the instruction to turn off sensors acquisition (when it is not moving or far from a road) in order to save energy and/or bandwidth, while keep using a CPU of the VRU's gateway 42 for edge-based machine learning training and update at the VRU gateway 42. The vehicle gateway 44 may move and take charge of specific, time-sensitive, computational tasks, and the collision predictor 46 at the cloud may take charge of CPU-intensive computational tasks such as machine learning training. In this communications configuration, the computational problem may take into account VRU and/or vehicle current conditions (such as when they are not moving, when they are far from a road, when wireless networks are unavailable, or when sensors interoperability is not functional, and/or when any other conditions at the edge prevail such that data acquisition may be unnecessary or poor) and may be subdivided into subproblems suitable for the computational power, the available energy, the available bandwidth, the data acquisition rate, of such nodes at the edge, as well as computational power, energy, and bandwidth saving constraints of such nodes at the edge. The communications configuration of the described technology is not limited to this embodied communications configuration.

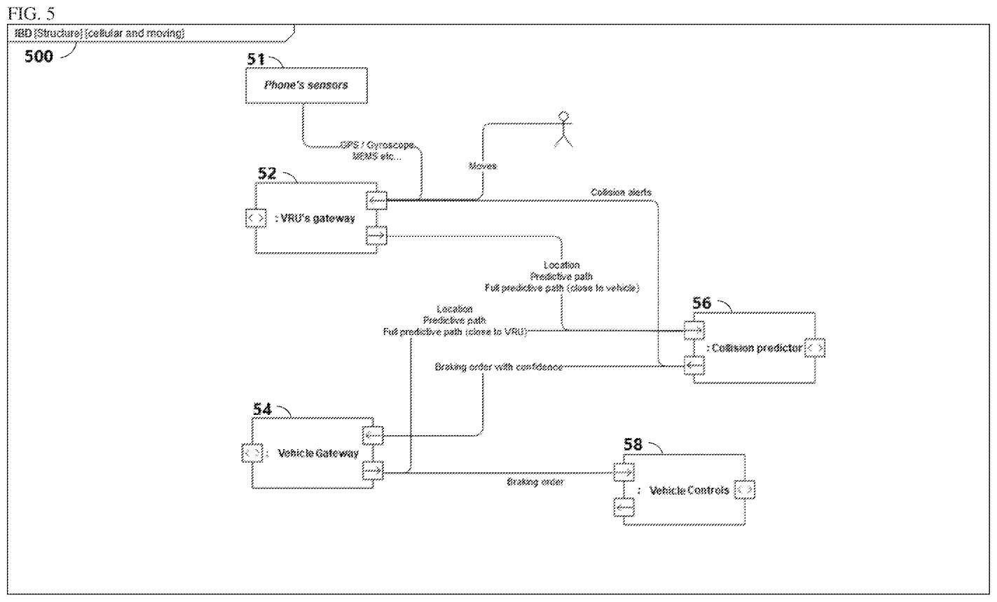

FIG. 5 illustrates one embodiment of a task distribution 500 for the method of collision avoidance between VRUs and vehicles. The task distribution 500 may include phone's sensors 51, a VRU's gateway 52, a vehicle gateway 54, a collision predictor 56, and a vehicle control (or a vehicle controller) 58. The communications configuration of the task distribution 500 is configured as an interconnected system comprising edge and cloud nodes and the VRU is moving across a wireless network comprising ITS-based standards, including 4G-LTE, 5G-LTE, LTE-M and C-V2X Uu cellular networks. The communications configuration relates mostly to cellular wireless communications infrastructure. In this embodiment of the described technology, the VRU's gateway 52 and the vehicle gateway 54 at the edge may take charge of specific, time-sensitive, computational tasks, whereas the collision predictor 56 at the cloud may take charge of CPU-intensive computational tasks such as machine learning training. In this communications configuration, the interconnected system may comprise mostly cellular nodes, where the problem may be subdivided into subproblems suitable for the available bandwidth and the data acquisition rate of such cellular nodes at the edge. The communications configuration of the described technology is not limited to this embodied communications configuration.

As shown in FIG. 5, when the VRU 20 moves, the VRU's gateway 52 can receive GPS, gyroscope, MEMS and/or other sensor data from the phone's sensors 51. The VRU's gateway 52 can also receive collision alert(s) from the collision predictor 56. Based at least in part on the sensor data and/or the collision alert, the VRU's gateway 52 can generate a location, a predictive path, and/or a full predictive path (which may be close to the vehicle 30). The collision predictor 56 may receive the location, the predictive path, and/or the full predictive path from the VRU's gateway 52, and may further receive a location, a predictive path, and a full predictor path (which may be close to the VRU 20) from the vehicle gateway 54. The collision predictor 56 can further generate a braking order with a confidence value based at least in part on the location, predictive path, and/or the full predictive path received from one or both of the VRU's gateway 52 and the vehicle gateway 54. The vehicle gateway 54 can receive the braking order with confidence from the collision predictor 56 and generate a braking order based at least in part on the braking order with confidence. The vehicle controller 58 can receive the braking order from the vehicle gateway 54 and control the vehicle to slow down or stop.

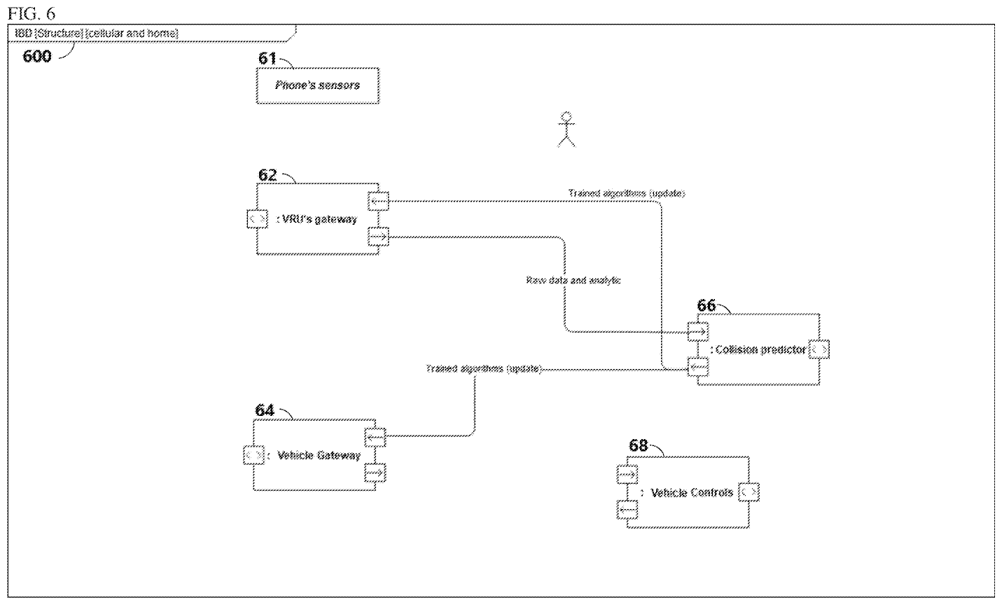

FIG. 6 illustrates one embodiment of a task distribution 600 for the method for collision avoidance between VRUs and vehicles. The task distribution 600 may include phone's sensors 61, a VRU's gateway 62, a vehicle gateway 64, a collision predictor 66, and a vehicle control (or a vehicle controller) 68. The communications configuration of the task distribution 600 is configured as an interconnected system comprising edge and cloud nodes and the VRU is not moving or is distal to a road. In this embodiment of the described technology, the VRU's gateway 62 may receive the instruction to turn off sensors acquisition (when it is not moving or far from a road) in order to save energy and bandwidth, while keep using its CPU for edge-based machine learning training and update at the VRU gateway 62. The vehicle gateway 64 may move and take charge of specific, time-sensitive, computational tasks and the collision predictor 66 at the cloud may take charge of CPU-intensive computational tasks such as machine learning training. In this communications configuration, the computational problem may take into account VRU and/or vehicle current conditions (such as when they are not moving, or when they are far from a road, when wireless networks are unavailable, when sensors interoperability is not functional, and/or when any other conditions at the edge prevail such that data acquisition may be unnecessary or poor) and may be subdivided into subproblems suitable for the computational power, the available energy, the available 4G-LTE, 5G-LTE, LTE-M or C-V2X Uu cellular bandwidth, the data acquisition rate, of such nodes at the Edge, as well as computational power, energy, and bandwidth saving constraints and costs constraints of such nodes at the edge. The communications configuration of the described technology is not limited to this embodied communications configuration.

As shown in FIG. 6, the VRU's gateway 62 can receive trained algorithms (for use in an update) from the collision predictor 66 and perform an update based at least in part on the trained algorithm. The VRU's gateway 62 can also generate raw data and analytics and provide the raw data and analytics to the collision predictor 66. The collision predictor 66 can generate the trained algorithms (for use in an update) for each of the VRU's gateway 62 and the vehicle gateway 64 based at least in part on the raw data and analytics received from the VRU's gateway 62. The vehicle gateway 64 can perform an update based at least in part on the trained algorithm received from the collision predictor 66. Similarly to the FIG. 5 embodiment, the vehicle controller 58 can receive a braking order from the vehicle gateway 54 and control the vehicle to slow down or stop.

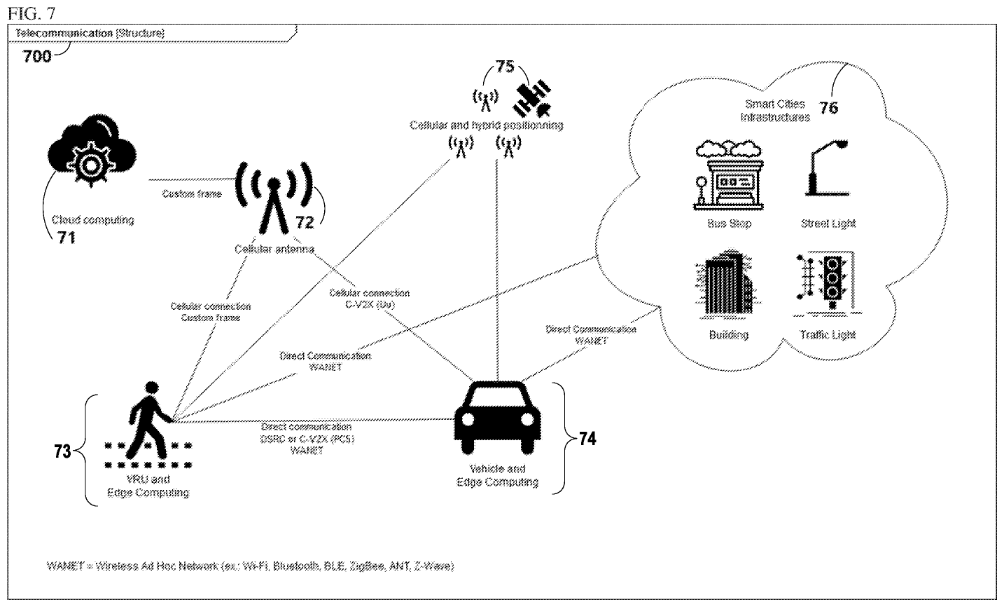

FIG. 7 illustrates one embodiment of a telecommunication structure 700 for collision avoidance between VRUs and vehicles. The telecommunication structure 700 may include a cloud computing element (or a cloud computing processor) 71, a cellular antenna 72, a VRU and edge computing element (or a RU and edge computing processor) 73, a vehicle and edge computing element (or a vehicle and edge computing processor) 74, a cellular and hybrid positioning element (a cellular and hybrid positioning processor) 75 and a smart city infrastructure 76 that includes, but is not limited to, a bus stop, a street light, a building and a traffic light. The telecommunication structure 700 may comprise an interconnected communications system between edge and cloud nodes, configured to any one of IEEE 802, IEEE 802.11, or IEEE 802.15 signal protocols, or a combination thereof. This interconnected communications system between edge and cloud nodes may be used and/or configured for communicating the communications server notification and providing the danger notification and for activating a proximity signal between two notified UE terminals, e.g., one UE terminal belonging to a vehicle and one UE terminal belonging to a VRU within a proximity range. The communications configuration of the described technology is not limited to this embodied communications configuration.

As shown in FIG. 7, the cloud computing element 71 can exchange a custom frame with the VRU's and vehicle's edge computing elements 73 and 74 via the cellular antenna. 72, The VRU's and vehicle's edge computing elements 73 and 74 may also directly communicate with each other via a direct connection (e.g., a DSRC, C-V2X (PC5), and/or WANET). In addition, the V1 U's and vehicle's edge computing elements 73 and 74 may also communicate with cellular and hybrid positioning to obtain location data via the cellular antenna 72 and the cellular and hybrid positioning element 75. The VRU's and vehicle's edge computing elements 73 and 74 may further communicate directly with the smart city infrastructure 76,

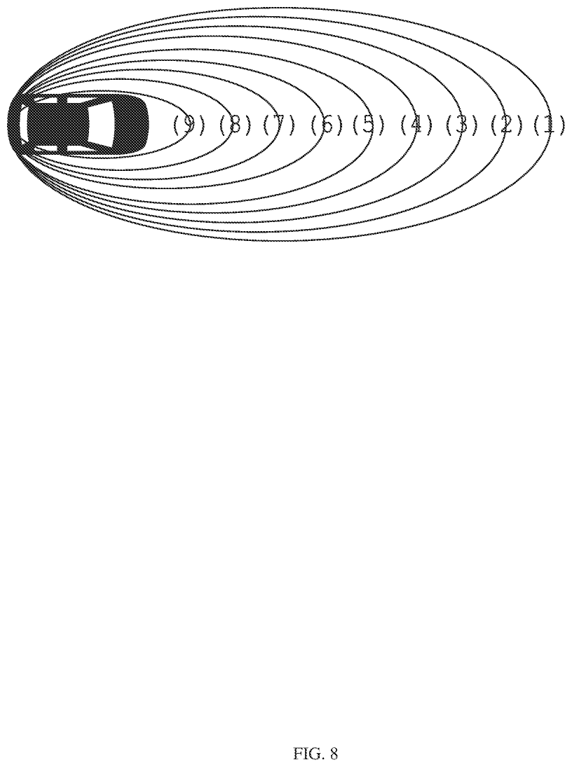

FIG. 8 illustrates one embodiment of the method for collision avoidance between VRUs and vehicles. The method comprises a set of rules for providing a danger notification that may relate to a proximity range shaped like an ellipse and/or shaped like a set of concatenated ellipses. When the vehicle is notified of a danger, the danger notification may relate to and/or may correlate to a proximity scale to the vehicle that may include (dx/dt)² braking-terms and (dy/dt)² swerving-terms in the predicted spatiotemporal trajectory of the notified UE terminal belonging to the vehicle, which relates approximately to the shape of an ellipse on the road. Since the capacity to brake is usually higher than the capacity to swerve (e.g., μₓ<μ_{y}), the predicted spatiotemporal trajectory of the notified UE terminal belonging to the vehicle may exhibit a higher trajectory probability along the longitudinal direction (e.g., the direction of driving) in order to maintain vehicle control, and a lower trajectory probability along the transversal direction (e.g., perpendicular to the direction of driving). This two-dimensional proximity scale for the trajectory probability may relate to a theoretical risk-factor in the collision-probability assessment, which may then determine the specific content of the danger notification.

In some embodiments, the danger notification may be different depending on the distance (or proximity range) between the VRU and the vehicle. In level 1, the distance between the vehicle and the VRU is farthest where the danger notification may indicate that there is a relatively low risk of collision. In level 9, the distance between the vehicle and the VRU is closest where the danger notification may indicate that there is a very high risk of collision. In some embodiments, the danger notification may indicate that levels 5-9 may be more dangerous than levels 1-4, and the VRU may be appropriately warned and/or the vehicle may be controlled to slow down or stop. In some embodiments, the danger notification may indicate that level 8 or 9 may be extremely dangerous. In these embodiments, the vehicle may be immediately stopped and/or the VRU may be alerted with an extreme danger. In some embodiments, the danger notification may indicate that level 1 or 2 may not be an immediate threat to the VRU. In these embodiments, a low risk warning may be given to the VRU and/or the vehicle. In some embodiments, the danger notification may indicate that level 5 or 6 may be a moderate threat to the VRU. In these embodiments, a moderate or medium level warning may be given to the VRU and/or the vehicle may be controlled to slow down or to prepare for slowing down.

According to some embodiments of the described technology, the danger notification may include different notifications depending on the risk-factor, e.g., the danger notification may include an information message if the risk-factor (or proximity scale to the vehicle) is at level 1, the danger notification may include a warning message if the risk-factor is at level 3, the danger notification may include an alert message if the risk-factor is at level 5, and/or the danger notification may include a prescription for collision avoidance if the risk-factor is at level 6 or more, etc. According to some embodiments of the described technology, the risk-factor may represent a range of plausible values (using percentage values, or using other normalized scales) for the collision probability between a VRU and a vehicle, computed from the statistics of the observed VRU and vehicle data. Other proximity scales to the notified vehicle may apply and are not limited to these examples. Also, other risk-factor shapes may apply and are not limited to ellipses. For example, the shape of the risk-factor may be more or less elongated given the specific standard deviations (σ) for tᵣ, μₓ and, μ_{y} which may vary for each vehicle. According to some embodiments of the described technology, and referring to FIG. 8, the risk-factor may take other oblong shapes depending on local road configurations and/or local road obstacles which may impact the range of plausible values for the collision probability between a VRU and a vehicle. According to another aspect of the described technology, and referring to FIG. 8, the risk-factor may take oblong cross-shapes if the local road configuration comprises one or more intersections.

According to some embodiments of the described technology, and referring to FIG. 8, the danger notification may be determined by the above-mentioned risk-factor as well as by other factors of empirical nature. According to some embodiments of the described technology, the danger notification may take into account several instrumental factors such as: the GPS accuracy of the UE terminals, the GPS swing (or GPS measurement variability), the number of available GPS/GLASS satellites signals accessed by the UE terminals, the GPS signal strength, the availability of dual frequency, the rate of data acquisition, and other instrumental factors related to the UE terminals. According to another aspect of the described technology, the danger notification may take into account LTE-related instrumental factors such as the LTE signal strength, the availability of 5G networks, the LTE tracking accuracy, or other LTE-related connectivity figures, etc. Accordingly, the method for collision avoidance between VRUs and vehicles may comprise a set of rules for providing a danger notification that may relate to, or may correlate to, a proximity scale to the vehicle that may include (dx/dt)² braking-terms and (dy/dt)² swerving-terms in the predicted spatiotemporal trajectory of the notified UE terminal belonging to the vehicle, as well as to a confidence factor expressing the accuracy, or the reliability, of the predicted spatiotemporal trajectory. The confidence factor may take into account several instrumental factors including the above-mentioned instrumental factors, it may vary according to GPS- and LTE-signal strengths and data accuracies, it may be computed from the variability statistics of the spatiotemporal data provided by the UE terminal belonging to the vehicle, and it may relate to a normalized reliability scale. For example, a confidence factor of 1 may be the highest (e.g., the spatiotemporal data of the vehicle can be trusted), and a confidence factor of 9 may be the lowest (e.g., the spatiotemporal data of the vehicle cannot be trusted), whereas a confidence factor of 5 may be medium confidence and may represent the minimum requirement for the present method and system to work accurately. According to some embodiments of the described technology, the confidence factor may be related to the precision of the spatiotemporal data of the vehicle as defined in the DSRC protocol, wherein the DSRC protocol relates to one-way or two-way short-range to medium-range wireless communication channels specifically designed for automotive use and for a corresponding set of protocols and standards.

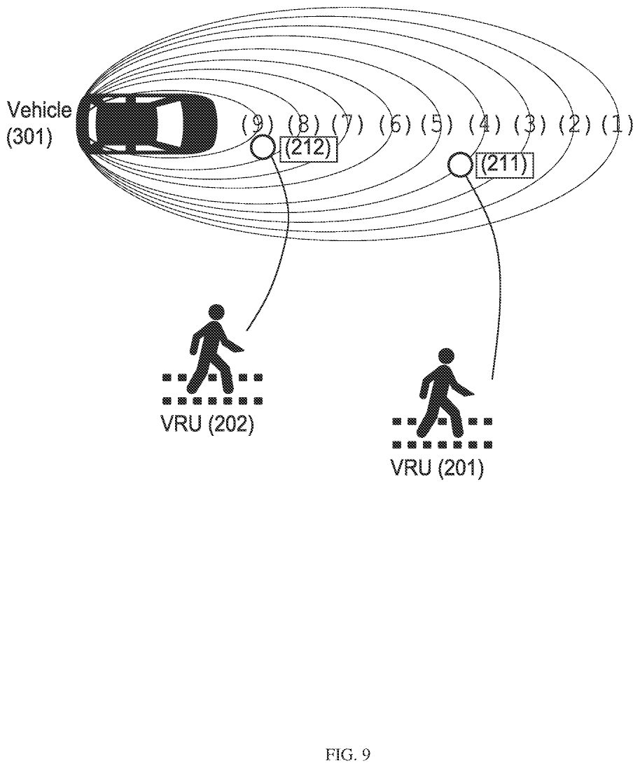

FIG. 9 illustrates one embodiment of the method for collision avoidance between VRUs and vehicles. The method comprises a set of rules for providing a danger notification that may relate to a proximity range shaped like an ensemble of n concatenated ellipses, wherein smaller ellipses relate to higher collision-probability assessments. According to some embodiments of the described technology, the dimensional safety margin M may relate to a risk-factor assessment, such that if the dimensional safety margin M is set at a small value, the risk of collision will be higher. For example, in the illustration of FIG. 9, the proximity range R (212) of the first VRU (202) is smaller than the proximity range R (211) of the second VRU (201), with respect to the same vehicle (301). Therefore, the proximity range R (212) may be labelled with a relatively high risk-factor considering the unsafe close approach between VRU (202) and vehicle (301) at future time t, as compared to the moderate close approach between VRU (201) and vehicle (301) at a different future time t. The communications server, acting as a cloud-component of a collision-avoidance system, may then provide a danger notification include a prescription for collision avoidance to VRU (202), a warning message to VRU (201), and/or a prescription for applying brakes to slow down or to stop for vehicle (301). Other danger notification may be implemented depending on the road context, and may use different communications configurations for the dispatch to the VRUs and vehicle, and different proximity signals may be sent between the VRUs and vehicle to optimize the collision avoidance.

According to some embodiments of the described technology, and referring to FIG. 9, the method for collision avoidance between VRUs and vehicles may comprise a set of rules that take into account risk factors as well as confidence factors, as described previously. For example, in the illustration of FIG. 9, the proximity range R (212) of the first VRU (202) is smaller than the proximity range R (211) of the second VRU (201), with respect to the same vehicle (301). However, the communications server, acting as a cloud-component of a collision-avoidance system, may provide a danger notification include a same warning message to both VRUs (201, 202) if the confidence factors are medium to low. According to some embodiments of the described technology, the danger notification may be weighted, moderated, determined, and/or assessed differently depending on the computed levels of both risk factors and confidence factors. According to one embodiment, the danger notification may be weighted, moderated, determined, and/or assessed as a “collision detection” if the risk-factor is 5 or higher, and if the confidence factor is 5 or lower, from which a prescription for applying brakes to slow down or to stop may be triggered through the ADAS or the ADS of the notified vehicle (301).

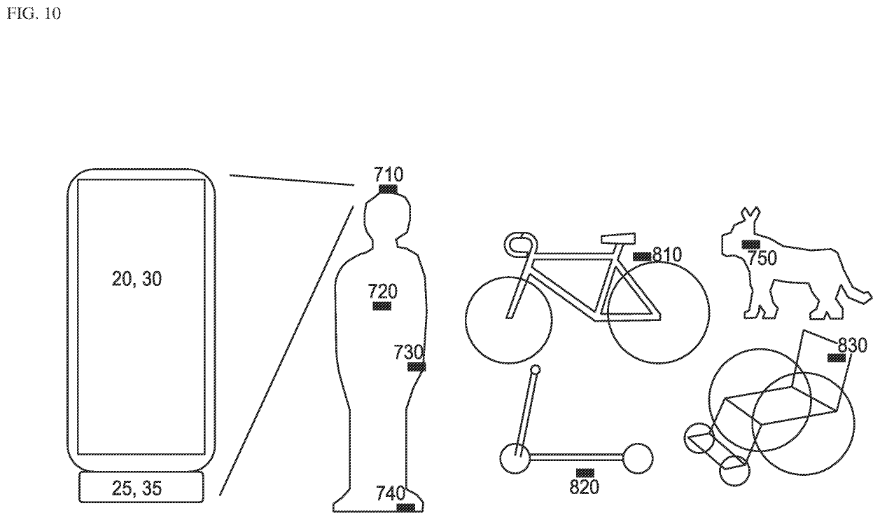

FIG. 10 illustrates one embodiment of the method for collision avoidance between VRUs and vehicles. The method comprises a LTE-capable UE terminal (20, 30) having an IMSI, that may be linked to a vehicle (301) or to a VRU (201, 202) (such as a mobile phone inserted in the pocket of the VRU or attached to the dashboard of the vehicle), and that may comprise an internally-integrated (20, 30) or externally-attached (25, 35) computational unit or processor (hardware, or firmware, or software) for processing an AI algorithm. The computational unit may be one of: a mobile application, a software, a firmware, a hardware, a physical device, a computing device, or a combination thereof. The VRU (201, 202) may refer to any human or living being that has to be protected from road hazards. The term can include but is not limited to: non-motorized road users such as pedestrians, construction workers, emergency services workers, policemen, firefighters, bicyclists, wheelchair users, or motorized road users such as scooters, motorcyclists, or any other VRUs or persons with disabilities or reduced mobility and orientation.

For example, a P2V collision avoidance method and system may involve at least one vehicle (301) and at least one VRU (201, 202) such as a pedestrian. The VRU may be associated with (e.g., physically linked to) at least one UE terminal (20) LTE-capable of 3G, 4G, 5G, etc. cellular communications. Although aspects of this disclosure are not limited to an embodiment in which a VRU is physically linked to an LTE-capable UE terminal, embodiments of this disclosure will be described in connection with these embodiments for the ease of description. However, those skilled in the art will recognize that other techniques for associating the UE terminal with a VRU. For example, the VRU may hold the UE terminal with his hand, attach it to a hat (710), place it in a pocket (720, 730), or insert it into a shoe (740), or in a bag, or attach it to a bicycle (810), scooter (820), wheelchair (830), or attach it a pet (750), etc. Likewise, the vehicle (301) may be associated with (e.g., physically linked or otherwise operatively coupled to) at least one LTE-capable UE terminal (30), such as a mobile phone secured on the dash board of a vehicle, or a LTE-capable UE terminal operatively coupled to an ADAS, or to an ADS of a vehicle, etc. These examples are not limiting examples. According to some embodiments of the described technology, the externally-attached (25, 35) computational unit or processor (hardware, or firmware, or software) may comprise a signal-modulation device for improving signal-to-noise ratio in reception and/or improving signal selectivity in reception (such as a positive-feedback amplifier, a heterodyne amplifier, or another transistor-based amplifier), in order to improve signal receptivity from one emitting notified UE terminal to the other receiving notified UE terminal for which the proximity signal is intended to be communicated.

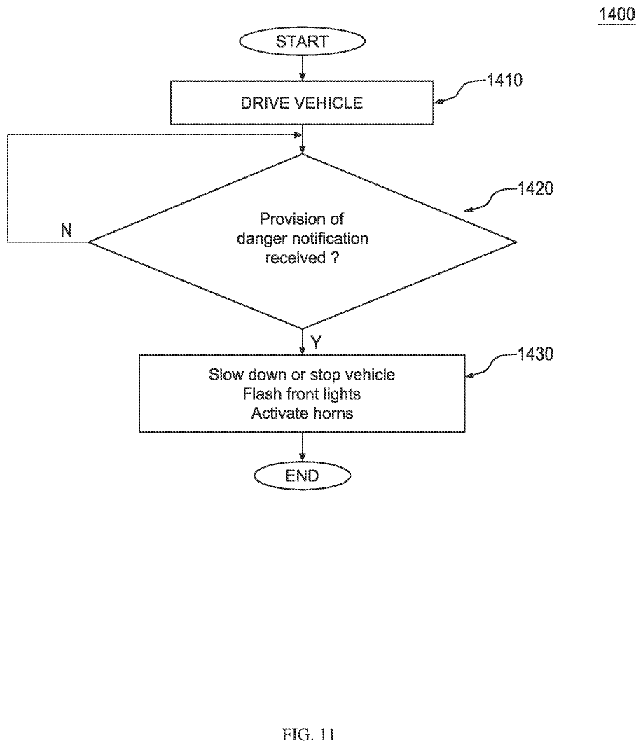

FIG. 11 illustrates an example flowchart for a process 1400 to be performed by a notified UE terminal linked to a vehicle, according to an embodiment of the described technology. The process 1400 can be enabled at the notified UE terminal if a communications server notification is received from the communication server, and if a provision of danger notification is received from the UE terminal linked to the corresponding notified VRU. According to some aspects of the described technology, and referring to FIGS. 10 and 11, the danger notification may include a prescription for collision avoidance intended for the VRU (e.g., an audible message or vibrating hum from the UE terminal (20, 25) warning the VRU of an impending danger), and of a warning message intended, and sent, to the approaching vehicle (e.g., an instruction of applying brakes to slow down or to stop for vehicle). FIG. 11 illustrates a notified UE terminal (30) linked to a vehicle according to an embodiment of the described technology, such a flowchart being enabled at the vehicle's notified UE terminal (30) if a communications server notification is received from the communication server (10), and if a danger notification is received from the UE terminal (20) linked to the corresponding notified VRU. The vehicle's notified UE terminal (30) may include a memory (not shown) storing instructions relating to the process 1400 and at least one processor (not shown) configured to execute the instructions to perform the process 1400.

According to the embodiment illustrated in FIG. 11, a notified UE terminal (30) linked to a vehicle may take the form of a feedback loop waiting to receive a danger notification. While the vehicle is driven (1410), if a danger notification is received from the UE terminal (20) linked to the corresponding notified VRU (1420), then a series of collision-avoidance measures may be triggered depending on the content of the danger notification, including, but not limited to, applying brakes to slow down or to stop for vehicle, flash front lights, or activate horns (1430). The series may comprise reading the content of the danger notification, and emitting an optical signal exhibiting time modulation, frequency modulation, phase modulation, polarization modulation, or a combination thereof. The emitted optical signal may include flashing the vehicle front lights (or any other LED lights) at a specific flash rate coincident with providing a cognitive sense of urgency to the VRU. The series may also comprise emitting an audible signal exhibiting time modulation, frequency modulation, or a combination thereof. The emitted audible signal may include activating the horns of the vehicle (or any other acoustic sound) at a specific pitch and cycle coincident with providing a cognitive sense of urgency to the VRU. Other measures may be provided in order to enhance the reactivity of the VRU upon receipt of a danger notification, including any audible, visual, haptic or cognitive message or any combination thereof.

Another inventive aspect of the present disclosure is a system for collision avoidance between VRUs and vehicles, the system comprising: a plurality of vehicles linked to LTE-capable UE terminals, a plurality of VRU linked to LTE-capable UE terminals and a communications server device. The communication server device can be configured to select a first number of the UE terminals, receive past spatiotemporal trajectory data from one or more sensors associated with each of the selected UE terminals and store the past spatiotemporal trajectory of each of the selected UE terminals. The communication server device can be further configured to first determine a machine learning model for predicting the future spatiotemporal trajectory of any one of each the selected UE terminals.

The communications server can comprise computer-executable instructions configured to perform spatiotemporal trajectory prediction and spatiotemporal crowd behavior prediction based on machine learning training. The communication server device can also be configured to send, to each of the selected UE terminals, the machine learning model configuration and machine learning model parameters. Each of the selected UE terminals can be configured to execute the machine learning model, receive the machine learning model configuration and machine learning model parameters and input, into the machine learning model, present spatiotemporal trajectory data from one or more sensors associated with each the selected UE terminals. Each of the selected UE terminals can be further configured to obtain, at the processor of each selected UE terminals, the predicted spatiotemporal trajectory of the selected UE terminal.

Each of the selected UE terminals can comprise computer-executable instructions configured to perform spatiotemporal trajectory prediction based on the received machine learning model configuration and parameters. Each of the selected UE terminals can also be configured to send, to the communications server device, the spatiotemporal trajectory prediction results. The communications server device can be configured to select a second number of the UE terminals, aggregate the spatiotemporal trajectory prediction results of the first number of the UE terminals, second determine whether the predicted spatiotemporal distance between any one of the first number of the UE terminals is within a proximity range and obtain a communications server notification if the second determining relates to a UE terminal belonging to a vehicle and a UE terminal belonging to a VRU. The communications server device can be further configured to tag these two UE terminals as notified UE terminals and to provide, for each the notified UE terminals, a danger notification pertaining to road usage safety.

According to one embodiment, the system may further be configured to perform acknowledging, at the notified UE terminals, the communications server notification. The communications server notification may include a duet comprising the MEID of the notified UE terminal belonging to the vehicle and the MEID of the notified UE terminal belonging to the VRU. The system may be further configured to perform the computational step of activating a proximity signal between the two notified UE terminals.

According to one embodiment, the system may be configured to provide a danger notification pertaining to road usage safety. The danger notification may include an information message, a warning message, an alert message, a prescription for danger avoidance, a prescription for collision avoidance, a prescription for moral conflict resolution, a statement of local applicable road regulations, a warning for obeying road regulations, any notification pertaining to road safety, or any combination thereof. A subset of this danger notification may comprise a prescription for collision avoidance including the prescription for applying brakes to slow down or to stop the vehicle through the ADAS or the ADS of the notified vehicle. Providing the danger notification may further comprise transmitting the danger notification to a communications network infrastructure, a road traffic infrastructure, a pedestrian crosswalk infrastructure, a cloud computing server, an edge computing device, an IoT device, a fog computing device, any information terminal pertaining to the field of road safety, or a combination thereof.

According to one embodiment, the system may comprise a communications server, wherein the communications server may include any one of an LCS server, an LTE BS server, an LTE wireless network communications server, a gateway server, a cellular service provider server, a cloud server, or a combination thereof. According to one embodiment, the system may comprise UE terminals further comprising GNSS-capable sensors, or GPS-capable sensors, MEMS accelerometer sensors, of MEMS gyroscope sensors, or an interoperable combination thereof. The UE terminals may include smartphones, IoT devices, tablets, ADAS, ADS, any other portable information terminals or mobile terminals, or a combination thereof.

According to one embodiment, the system may involve a plurality of VRUs and vehicles linked to LTE-capable UE terminals having an IMSI, wherein the LTE equipment may use 5G NR new RAT developed by 3GPP for 5G mobile networks.

According to one embodiment, the system may provide the radio equipment necessary to trigger a proximity signal, wherein the proximity signal may include a radio frequency communications configured to any one of IEEE 802, IEEE 802.11, or IEEE 802.15 signal protocols, or a combination thereof. Also, the proximity signal may be configured to be generated with an interoperable system that communicates with an ITS-based standard, including DSRC, 4G-LTE, 5G-LTE, LTE-M, or C-V2X.

The various illustrative blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of the method and the functions of the system described in connection with the embodiments disclosed herein may be embodied directly in hardware, in firmware, or in a software module executed by a processor, or in a combination of the three. If implemented in software, the system functions may be stored on or transmitted over as one or more instructions or code on a tangible, non-transitory computer-readable medium. A software module may reside in random access memory (RAM), flash memory, read only memory (ROM), electrically programmable ROM (EPROM), electrically erasable programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

Those skilled in the art will appreciate that, in some embodiments, additional components and/or steps can be utilized, and disclosed components and/or steps can be combined or omitted.

The above description discloses embodiments of systems, apparatuses, devices, methods, and materials of the present disclosure. This disclosure is susceptible to modifications in the components, parts, elements, steps, and materials, as well as alterations in the fabrication methods and equipment. Such modifications will become apparent to those skilled in the art from a consideration of this disclosure or practice of the disclosure. Consequently, it is not intended that the disclosure be limited to the specific embodiments disclosed herein, but that it cover all modifications and alternatives coming within the scope and spirit of the described technology.

What is claimed is:

1. A method for collision avoidance between vulnerable road users (VRUs) and vehicles, the method comprising:
linking, to a plurality of vehicles and to a plurality of VRUs, long-term evolution (LTE)-capable user equipment (UE) terminals having an international mobile subscriber identity (IMSI);
first selecting, at a communications server, a first number of the UE terminals, wherein the first selection comprises:
receiving past spatiotemporal trajectory data from one or more sensors associated with each of the selected UE terminals;
storing the past spatiotemporal trajectory data of each of the selected UE terminals;
first determining a machine learning model for predicting a future spatiotemporal trajectory of any one of the selected UE terminals, wherein the communications server comprises computer-executable instructions configured to perform spatiotemporal trajectory prediction and spatiotemporal crowd behavior prediction based on machine learning training;
sending, to each of the selected UE terminals, a machine learning model configuration and machine learning model parameters; and
causing each of the selected UE terminals to execute the machine learning model to perform:
receiving the machine learning model configuration and machine learning model parameters;
inputting, into the machine learning model, present spatiotemporal trajectory data from the one or more sensors associated with each of the selected UE terminals;
obtaining, at a processor of each of the selected UE terminals, a predicted spatiotemporal trajectory of each selected UE terminal, wherein each of the selected UE terminals comprises computer-executable instructions configured to perform the spatiotemporal trajectory prediction based on the received machine learning model configuration and parameters; and
sending, to the communications server, results of the spatiotemporal trajectory prediction; and
second selecting, at the communications server, a second number of the UE terminals, wherein the second selecting comprises:
aggregating the results of the spatiotemporal trajectory prediction for the selected first number of the UE terminals;
second determining whether the predicted spatiotemporal distance between any one pair of the selected first number of the UE terminals is within a proximity range;
obtaining a communications server notification in response to the second determining relating to a first one of the UE terminals belonging to one of the vehicles and a second one of the UE terminals belonging to one of the VRUs;
tagging the first and second UE terminals as notified UE terminals; and
providing, to the notified UE terminals, a danger notification pertaining to road usage safety.

2. The method of claim 1, wherein the second selecting further comprises receiving an acknowledgement of the communications server notification from the notified UE terminals.

3. The method of claim 2, wherein the acknowledgement is based on activating a proximity signal between the first and second notified UE terminals.

4. The method of claim 3, wherein the proximity signal includes a radio frequency communications configured to be implemented with any one of IEEE 802, IEEE 802.11, or IEEE 802.15 signal protocols, or a combination thereof.

5. The method of claim 4, wherein the proximity signal is configured to be generated by an interoperable system that communicates with an intelligent transportation systems (ITS)-based standard, including at least one of: dedicated short-range communications (DSRC), LTE, and cellular vehicle-to-everything (C-V2X) communications.

6. The method of claim 5, wherein the communications server notification includes a duet comprising a mobile equipment identifier (MEID) of the first notified UE terminal belonging to the vehicle and the MEID of the second notified UE terminal belonging to the VRU.

7. The method of claim 6, wherein the danger notification includes an information message, a warning message, an alert message, a prescription for danger avoidance, a prescription for collision avoidance, a prescription for moral conflict resolution, a statement of local applicable road regulations, a warning for obeying road regulations, an audible message, a visual message, a haptic message, a cognitive message, any notification pertaining to road safety, or any combination thereof.

8. The method of claim 7, wherein the prescription for collision avoidance includes a prescription for applying brakes to slow down or to stop the vehicle through an advanced driver assistant system (ADAS) or an automated driving system (ADS) of the notified vehicle.

9. The method of claim 7, wherein the proximity signal comprises the communications server notification and the danger notification.

10. The method of claim 9, wherein providing the danger notification further comprises transmitting the danger notification to a communications network infrastructure, a road traffic infrastructure, a pedestrian crosswalk infrastructure, a cloud computing server, an edge computing device, an Internet of things (IoT) device, a fog computing device, any information terminal pertaining to the field of road safety, or a combination thereof.

11. The method of claim 1, wherein the communications server includes any one of a location service client (LCS) server, an LTE base station (BS) server, an LTE wireless network communications server, a gateway server, a cellular service provider server, a cloud server, or a combination thereof.

12. The method of claim 11, wherein the UE terminals further comprise global navigation satellite systems (GNSS)-capable sensors, global positioning system (GPS)-capable sensors, microelectromechanical (MEMS) accelerometer sensors, of MEMS gyroscope sensors, or an interoperable combination thereof.

13. The method of claim 12, wherein the UE terminals include smartphones, Internet of things (IoT) devices, tablets, advanced driver assistant systems (ADAS), automated driving systems (ADS), any other portable information terminals, mobile terminals, or a combination thereof.

14. The method of claim 1, wherein the machine learning model includes a dead reckoning algorithm, an artificial intelligence algorithm, a recurrent neural network (RNN) algorithm, a reinforcement learning (RL) algorithm, a conditional random fields (CRFs) algorithm, or a combination thereof.

15. The method of claim 14, wherein the communications server is configured to train the machine learning model using a set of spatiotemporal trajectory data comprising position, speed, acceleration, and/or direction components, or a combination thereof, of any one of the UE terminals.

16. The method of claim 14, wherein the processor of each of the selected UE terminals is configured to execute the machine learning model using model configuration and model parameters.

17. A system for collision avoidance between vulnerable road users (VRUs) and vehicles, the system comprising:
a communications server comprising computer-executable instructions configured to perform spatiotemporal trajectory prediction and spatiotemporal crowd behavior prediction based on machine learning training, the communications server configured to:
select a first number of long-term evolution (LTE)-capable user equipment (UE) terminals having an international mobile subscriber identity (IMSI), wherein each of the UE terminals is linked to a vehicle or a VRU;
receive past spatiotemporal trajectory data from one or more sensors associated with each of the selected UE terminals;
store the past spatiotemporal trajectory data of each of the selected UE terminals;
first determine a machine learning model for predicting a future spatiotemporal trajectory of any one the selected UE terminals;
send, to each of the selected UE terminals, a machine learning model configuration and machine learning model parameters;
cause each of the selected UE terminals to:
execute the machine learning model;
receive the machine learning model configuration and machine learning model parameters;
input, into the machine learning model, present spatiotemporal trajectory data from one or more sensors associated with the selected UE terminals;
obtain, at a processor of each of the selected UE terminals, the predicted spatiotemporal trajectory of each selected UE terminal, wherein each of the selected UE terminals comprises computer-executable instructions configured to perform spatiotemporal trajectory prediction based on the received machine learning model configuration and parameters; and
send, to the communications server, results of the spatiotemporal trajectory prediction,
the communications server further configured to:
select a second number of the UE terminals;
aggregate the results of the spatiotemporal trajectory prediction for the selected first number of the UE terminals;
second determine whether the predicted spatiotemporal distance between any one pair of the first number of the UE terminals is within a proximity range;
obtain a communications server notification in response to the second determining relating to a first one of the UE terminals belonging to one of the vehicles and a second one of the UE terminals belonging to one of the VRUs;
tag the first and second UE terminals as notified UE terminals; and
provide, to each of the notified UE terminals, a danger notification pertaining to road usage safety.

18. The system of claim 17, wherein the communications server is further configured to receive an acknowledgement of the communications server notification from the notified UE terminals.

19. The system of claim 18, wherein the acknowledgement is based on activating a proximity signal between the notified UE terminals.

20. A non-transitory computer readable medium, having stored thereon instructions that, when executed by a processor, cause the processor to:
link, to a plurality of vehicles and to a plurality of VRUs, long-term evolution (LTE)-capable user equipment (UE) terminals having an international mobile subscriber identity (IMSI);
first select, at a communications server, a first number of the UE terminals, wherein the first selection comprises:
receiving past spatiotemporal trajectory data from one or more sensors associated with each of the selected UE terminals;
storing the past spatiotemporal trajectory data of each of the selected UE terminals;
first determining a machine learning model for predicting a future spatiotemporal trajectory of any one of the selected UE terminals, wherein the communications server comprises computer-executable instructions configured to perform spatiotemporal trajectory prediction and spatiotemporal crowd behavior prediction based on machine learning training;
sending, to each of the selected UE terminals, a machine learning model configuration and machine learning model parameters; and
causing each of the selected UE terminals to execute the machine learning model to perform:
receiving the machine learning model configuration and machine learning model parameters;
inputting, into the machine learning model, present spatiotemporal trajectory data from the one or more sensors associated with each of the selected UE terminals;
obtaining, at a processor of each of the selected UE terminals, a predicted spatiotemporal trajectory of each selected UE terminal, wherein each of the selected UE terminals comprises computer-executable instructions configured to perform the spatiotemporal trajectory prediction based on the received machine learning model configuration and parameters; and
sending, to the communications server, results of the spatiotemporal trajectory prediction; and
second select, at the communications server, a second number of the UE terminals, wherein the second selecting comprises:
aggregating the results of the spatiotemporal trajectory prediction for the selected first number of the UE terminals;
second determining whether the predicted spatiotemporal distance between any one pair of the first number of the UE terminals is within a proximity range;
obtaining a communications server notification in response to the second determining relating to a first one of the UE terminals belonging to one of the vehicles and a second one of the UE terminals belonging to one of the VRUs;
tagging the first and second UE terminals as notified UE terminals; and
providing, to the notified UE terminals, a danger notification pertaining to road usage safety.
